(19) United States
(12) Patent Application Publication
(10) Pub. No.: US 2025/0238958 A1
(43) Pub. Date: Jul. 24, 2025

(54) Color Data Format Conversion On The Fly

(71) Applicant: QUALCOMM Incorporated, San Diego, CA (US)

(72) Inventors: George PATSILARAS, San Diego, CA (US); Andrew Edmund TURNER, San Diego, CA (US)

(21) Appl. No.: 18/420,643

(22) Filed: Jan. 23, 2024

(51) Int. Cl. G06T 9/00; G06T 7/90; G06V 10/56

(52) U.S. Cl. CPC G06T 9/00; G06T 7/90; G06V 10/56; G06T 2207/10024

(57) ABSTRACT

Various embodiments include methods for image compression and decompression. Some embodiments may include identifying locations of image color data of a portion of an image within a portion of a memory in an interleaved format, and encoding metadata, which may be image data format agnostic, with a location identifier that describes locations of the image color data of the portion of the image within the portion of the memory in the interleaved format. Some embodiments may include decoding the metadata with a location identifier configured to describe locations of image color data of a portion of an image within a portion of a memory in an interleaved format, and identifying the locations of the image color data of the portion of the image within the portion of the memory in the interleaved format from the location identifier.

### BACKGROUND

Power efficiency is an important aspect of operation for many computing devices, particularly battery powered computing devices with a finite power supply. In some computing devices image data shared between processing devices may be allocated into static random access memory (SRAM) rather than dynamic random access memory (DRAM). However, image data is formatted and not all processing devices can efficiently process all image buffer formats.

### SUMMARY

Various aspects include systems and methods of image compression that may be performed by a processing system of a computing device. Various aspects may include identifying locations of image color data of a portion of an image within a portion of a memory in an interleaved format, and encoding a metadata with a location identifier configured to describe the locations of the image color data of the portion of the image within the portion of the memory in the interleaved format. In some aspects, encoding the metadata may include encoding image data format agnostic metadata.

Some aspects may further include generating the location identifier based on the locations of the image color data of the portion of the image within the portion of the memory in the interleaved format.

In some aspects, the location identifier may be configured to indicate to an image decoder device that a component of the image color data is one of compressed as part of a previous block, begins a first sized block, begins a second sized block, is a first constant value, or is a second constant value. In some aspects, the location identifier may be configured to indicate to an image decoder device that all components of the image color data are a constant value. In some aspects, the location identifier may be configured to indicate to an image decoder device that a beginning component of the image color data begins a first sized block, begins a second sized block, is a first constant value, or is a second constant value.

In some aspects, the image color data of the portion of the image within the portion of the memory in the interleaved format may include compressed image color data for at least one component of the image color data. In some aspects, the image color data of the portion of the image within the portion of the memory in the interleaved format may include a plurality of components of the image color data such that each of the plurality of components represents one of a color value or a transparency value.

Various aspects include systems and methods of image decompression that may be performed by a processing system of a computing device. Various aspects may include decoding a metadata with a location identifier configured to describe locations of image color data of a portion of an image within a portion of a memory in an interleaved format, and identifying the locations of the image color data of the portion of the image within the portion of the memory in the interleaved format from the location identifier. In some aspects, the metadata may be image data format agnostic.

In some aspects, identifying the locations of the image color data of the portion of the image within the portion of the memory in the interleaved format from the location identifier may include identifying the locations of the image color data of the portion of the image within the portion of the memory in the interleaved format from values that are associated with the location identifier, in which each of the values is configured to represent a location of one of multiple components of the image color data of the portion of the image within the portion of the memory in the interleaved format.

In some aspects, decoding the metadata with the location identifier configured to describe the locations of the image color data of the portion of the image within the portion of the memory in the interleaved format may include locating values configured to represent locations of multiple components of the image color data of the portion of the image within the portion of the memory in the interleaved format based on the location identifier.

In some aspects, decoding the metadata with the location identifier configured to describe the locations of the image color data of the portion of the image within the portion of the memory in the interleaved format may include generating values configured to represent locations of multiple components of the image color data of the portion of the image within the portion of the memory in the interleaved format based on the location identifier.

In some aspects, the location identifier may be configured to indicate to an image decoder device that a component of the image color data is one of compressed as part of a previous block, begins a first sized block, begins a second sized block, is a first constant value, or is a second constant value. In some aspects, the location identifier may be configured to indicate to an image decoder device that all components of the image color data are a constant value. In some aspects, the location identifier may be configured to indicate to an image decoder device that a beginning component of the image color data begins a first sized block, begins a second sized block, is a first constant value, or is a second constant value.

In some aspects, the image color data of the portion of the image within the portion of the memory in the interleaved format includes compressed image color data for at least one component of the image color data. In some aspects, the image color data of the portion of the image within the portion of the memory in the interleaved format may include a plurality of components of the image color data such that each of the plurality of components represents one of a color value or a transparency value.

Further aspects may include a computing device having a processor configured to perform one or more operations of any of the methods summarized above. Further aspects may include a non-transitory processor-readable storage medium having stored thereon processor-executable instructions configured to cause a processor of a computing device to perform operations of any of the methods summarized above. Further aspects include a computing device having means for performing functions of any of the methods summarized above. Further aspects include a system on chip for use in a computing device that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1 is a system block diagram illustrating an example communication system suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIGS. 4A and 4B are component block diagrams illustrating a system configured for image compression and image decompression in accordance with various embodiments.

FIGS. 5A and 5B are component block diagrams of example image data formats in a memory in accordance with various embodiments.

FIG. 6 is a component block diagram of an example of compressed image data of different image data formats in a memory in accordance with some embodiments.

FIG. 7 is a table diagram of a mapping of location identifiers of encoded metadata with values configured to represent locations of components of image color data in accordance with some embodiments.

FIG. 8 is a component block diagram of an example of compressed image data including image data format agnostic metadata in a memory in accordance with some embodiments.

FIG. 9 is a process flow diagram illustrating a method that may be performed by a processing system of a computing device for image compression in accordance with some embodiments.

FIG. 10 is a process flow diagram illustrating a method that may be performed by a processing system of a computing device for image decompression in accordance with some embodiments.

FIG. 11A is a process flow diagram illustrating a method that may be performed by a processor of a computing device for image compression in accordance with some embodiments.

FIG. 11B is conceptual block diagram illustrating examples of image data compression schema in accordance with some embodiments.

FIG. 11C is a conceptual block diagram illustrating examples of metadata encodings in accordance with some embodiments.

FIG. 11D is a conceptual block diagram illustrating examples of metadata encodings in accordance with some embodiments.

FIG. 12 is a process flow diagram illustrating operations that may be performed by a processor of a computing device as part of the method for image compression according to some embodiments.

FIG. 13A is a process flow diagram illustrating a method that may be performed by a processor of a computing device for image decompression in accordance with some embodiments.

FIG. 13B is a conceptual block diagram illustrating an example of image decompression operations in accordance with some embodiments.

FIG. 14 is a component block diagram of a network computing device suitable for use with some embodiments.

FIG. 15 is a component block diagram of a wireless device suitable for use with some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes and are not intended to limit the scope of the claims.

Various embodiments include systems and methods for managing data compression and decompression of image data to facilitate access to the image data by different processing systems configured for different image data formats. Various embodiments may improve the efficiency and utility of computing devices by reducing processes and energy for different processors and/or processing systems of the computing devices for accessing stored image data of different image data formats. Various embodiments may include metadata that is agnostic to the image data format (referred to as an image data format agnostic metadata) having a location identifier configured to describe locations of image color data of a portion of an image within a portion of a memory in an interleaved format. Some embodiments may include a location identifier configured to describe the locations of the image color data of the portion of the image within the portion of the memory in the interleaved format. Some embodiments may include interpreting the location identifier to retrieve the image color data of the portion of the image in accordance with an image data format of a processing system regardless of the image data format of the image color data of the portion of the image within the portion of the memory.

The term “computing device” is used herein to refer to any one or all of wireless or wired router devices, server devices, and other elements of a communication network, wireless or wired appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., wireless gaming controllers, music and video players, satellite radios, etc.), wireless-network enabled Internet of Things (IoT) devices including smart meters/sensors, industrial manufacturing equipment, large and small machinery and appliances for home or enterprise use, wireless communication elements within autonomous and semiautonomous vehicles, wireless devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

The term “packing” is used herein to refer to data compression techniques used to reduce the number of bits of information to store and/or transmit digital information, such as image data or a data stream of multimedia data, so that the original digital information can be recovered via decompression (sometimes referred to herein as “unpacking”) without substantial reduction in the quality or fidelity of the original data. Image compression (i.e., image data packing) is widely used in the telecommunication industry and a number of data compression or packing techniques are known and used. There are a number of known data packing techniques, and references herein to “type of packing” refers to the particular packing or data compression used for a chunk of data, which may include tiled types of packing techniques that compress data in terms of tiles or linear types of data packing techniques that compress data in a linear manner.

Power efficiency is an important aspect of operation for many computing devices, particularly battery powered computing devices with a finite power supply. In some computing devices image data shared between processing devices may be allocated into SRAM rather than DRAM. However, image data is formatted and not all processing devices of a computing device can efficiently process all types of image buffer formats.

The inability to directly process image data formats for which the processing device is not configured may require processes that would otherwise not be required by a processing device configured for the image data format. For example, for a processing device not configured for the image data format requires processes to convert the image data in the unsupported image data format to a supported image data format for which the processing device is configured. As another example, multiple accesses to the image data can be implemented by a processing device not configured for the image data format to retrieve all the need image data, whereas a processing device configured for the image data format can retrieve all the needed image data in one access to the image data. Any additional processes required by the processing device not configured for the image data format incur additional costs in power efficiency and performance speed compared to processing devices configured for the image data format.

Various embodiments address and overcome the foregoing problems by implementing metadata, such as image data format agnostic metadata, having a location identifier that may be configured to describe locations of image color data of a portion of an image within a portion of a memory in an interleaved format. The metadata may be agnostic to the image data format as the metadata may be configured to represent interleaved format image data in a manner usable by any processing system configured for interleaved format image data or non-interleaved format data. The location identifier may be configured to describe the locations of the image color data of the portion of the image within the portion of the memory in the interleaved format. Using the location identifier from the metadata, a processing system not configured for interleaved formatted image data may access the image color data of the portion of the image within the portion of the memory without regard to the interleaved image data format. In other words, the image data in the interleaved format may not need to be converted to an image data format supported by a processing system not configured for the interleaved formatted image data. Also, a processing system not configured for the interleaved formatted image data may avoid making multiple access to retrieve specific image color data by accessing locations for the specific image color data indicated by the location identifier.

Various embodiments may enable a processing system (e.g., GPU) configured for an interleaved image data format (e.g., RGBA) to write to and/or read from a memory interleaved format image data. Various embodiments may also enable a processing system (e.g., a digital processing unit (DPU)) configured for a non-interleaved image data format, such as a component image data format (e.g., red-green-blue (RGB) Planer), to read individual components from the interleaved format image data at the memory. The processing system configured for the interleaved image data format may retain efficient access to the interleaved format image data during read and write operations. The processing system configured for a non-interleaved image data format may directly read the individual components from the interleaved format image data. Traditional conversion processes, such as copy operations which would read the interleaved format and output a non-interleaved format, may be avoided. Less memory may be occupied for the image data by avoiding having to store a non-interleaved format image data converted from the interleaved format image data.

Various embodiments may be implemented in software, firmware, hardware (e.g., circuitry), or a combination of software and hardware, which are configured to perform particular operations or functions. Some embodiments may be implemented in hardware configured to perform operations or functions, with or without executing instructions. Some embodiments may be implemented in a processing system, a system on chip (SOC), a network on-chip (NOC), or another suitable implementation.

While the following examples and embodiments are described with reference to specific amounts of data or sizes of data groupings, such amounts or sizes are examples used for the purposes of illustration, and while useful in many applications and implementations, are not intended to be limiting. For example, a processing system of a computing device may write and/or read 256-byte image color data. The image color data may include 64-byte chunks for each component (e.g., red, green, blue, alpha) of the image color data, and compress or decompress each 64-byte chunk individually. In some cases, a 64-byte chunk may not be compressed. In such embodiments, the computing device may store the image color data in 32-byte blocks for encoding and decoding. Various embodiments may be useful in enabling processing systems of the computing device configured for different image data formats to efficiently access that same image data.

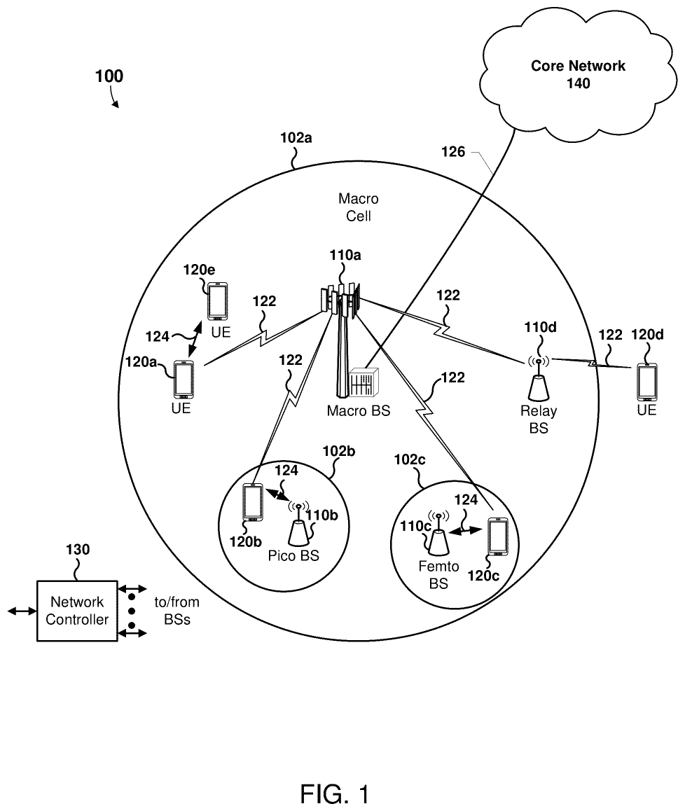

FIG. 1 is a system block diagram illustrating an example communication system 100 suitable for implementing any of the various embodiments. The communications system 100 may be a 5G New Radio (NR) network, or any other suitable network such as a Long Term Evolution (LTE) network.

The communications system 100 may include a heterogeneous network architecture that includes a core network 140 and a variety of wireless devices (illustrated as wireless devices 120a-120e in FIG. 1). The wireless devices 120a-120e are examples of computing devices. The communications system 100 may also include a number of base stations (illustrated as the BS 110a, the BS 110b, the BS 110c, and the BS 110d) and other network entities. A base station is an entity that communicates with wireless devices, and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

A base station 110a-110d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 110a may be a macro BS for a macro cell 102a, a base station 110b may be a pico BS for a pico cell 102b, and a base station 110c may be a femto BS for a femto cell 102c. A base station 110a-110d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 110a-110d may be interconnected to one another as well as to one or more other base stations or network nodes (not illustrated) in the communications system 100 through various types of backhaul interfaces, such as a direct physical connection, a virtual network, or a combination thereof using any suitable transport network.

The base station 110a-110d may communicate with the core network 140 over a wired or wireless communication link 126. The wireless device 120a-120e may communicate with the base station 110a-110d over a wireless communication link 122.

The wired communication link 126 may use a variety of wired networks (e.g., Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (e.g., relay BS 110d). A relay station is an entity that can receive a transmission of data from an upstream station (for example, a base station or a wireless device) and transmit the data to a downstream station (for example, a wireless device or a base station). A relay station also may be a wireless device that can relay transmissions for other wireless devices. In the example illustrated in FIG. 1, a relay station 110d may communicate with macro the base station 110a and the wireless device 120d in order to facilitate communication between the base station 110a and the wireless device 120d. A relay station also may be referred to as a relay base station, a relay base station, a relay, etc.

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 120a, 120b, 120c may be dispersed throughout communications system 100, and each wireless device may be stationary or mobile. A wireless device also may be referred to as an access terminal, a terminal, a mobile station, a subscriber unit, a station, etc.

A macro base station 110a may communicate with the communication network 140 over a wired or wireless communication link 126. The wireless devices 120a, 120b, 120c may communicate with a base station 110a-110d over a wireless communication link 122.

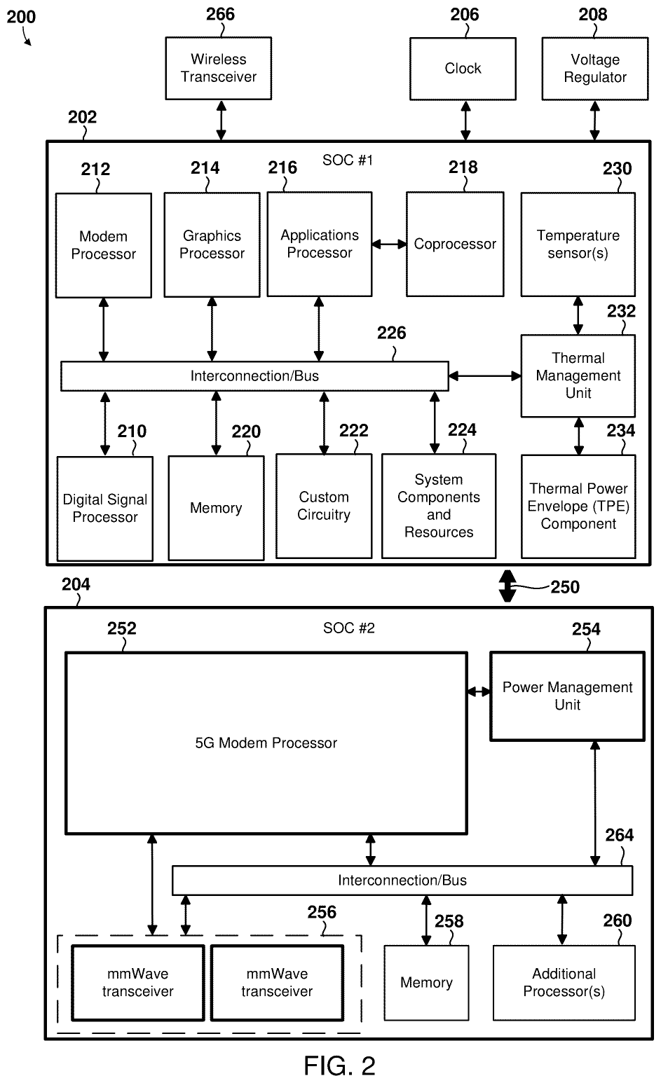

FIG. 2 is a component block diagram illustrating an example processing system 200 suitable for implementing any of the various embodiments. Various embodiments may be implemented on a number of single processor and multiprocessor computer systems, including a system-on-chip (SOC) or system in a package (SIP).

With reference to FIGS. 1 and 2, the illustrated example processing system 200 (which may be a SIP in some embodiments) includes two SOCs 202, 204 coupled to a clock 206, a voltage regulator 208, and a wireless transceiver 266 configured to send and receive wireless communications via an antenna (not shown) to/from wireless devices, such as a base station 110a. In some embodiments, the first SOC 202 operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wavelength (e.g., 28 GHz mmWave spectrum, etc.) communications.

The first SOC 202 may include one or more processing systems that may each be one or more of any of a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include one or more processing systems that may each be one or more of any of a 5G modem processor 252, a power management unit 254, an interconnection/bus module 264, the plurality of mmWave transceivers 256, memory 258, and various additional processors 260, such as an applications processor, packet processor, etc.

Each processing system 210, 212, 214, 216, 218, 252, 260 may include one or more processors/cores, and each processor/core may perform operations independent of the other processors/cores. For example, the first SOC 202 may include a processing system that executes a first type of operating system (e.g., FreeBSD, LINUX, OS X, etc.) and a processing system that executes a second type of operating system (e.g., MICROSOFT WINDOWS 10). In addition, any or all of the processing systems 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processing systems and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, within the processing system 200 may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processing systems 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The processing system 200 may further include an input/output module (not illustrated) for communicating with resources external to the SOC, such as a clock 206 and a voltage regulator 208. Resources external to the processing system 200 (e.g., clock 206, voltage regulator 208) may be shared by two or more of the internal SOC processing systems 202, 204.

In addition to the example SIP 200 discussed above, various embodiments may be implemented in a wide variety of computing systems, which may include a processing system that may include any of a single processor, multiple processors, multicore processors, or any combination thereof.

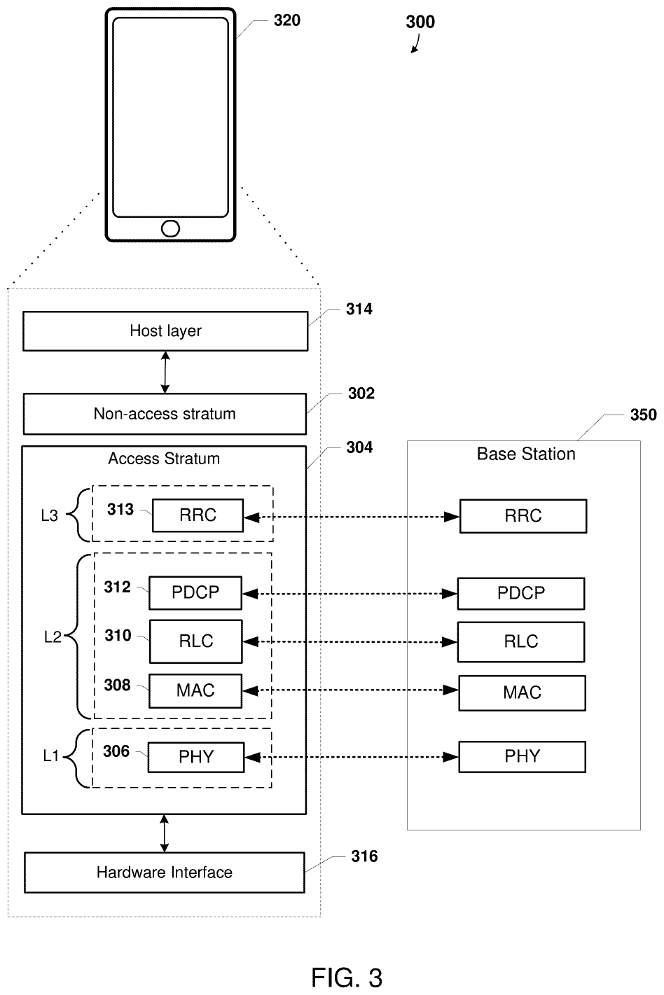

FIG. 3 is a component block diagram illustrating a software architecture 300 including a radio protocol stack for the user and control planes in wireless communications suitable for implementing any of the various embodiments. With reference to FIGS. 1-3, the wireless device 320 may implement the software architecture 300 to facilitate communication between a wireless device 320 (e.g., the wireless device 120a-120e, 200) and the base station 350 (e.g., the base station 110a) of a communication system (e.g., 100). In various embodiments, layers in software architecture 300 may form logical connections with corresponding layers in software of the base station 350. The software architecture 300 may be distributed among one or more processors (e.g., the processors 212, 214, 216, 218, 252, 260) within a processing system (e.g., 200). While illustrated with respect to one radio protocol stack, in a multi-SIM (subscriber identity module) wireless device, the software architecture 300 may include multiple protocol stacks, each of which may be associated with a different subscriber identity module (SIM) (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (e.g., SIM(s) 204) and its core network 140. The AS 304 may include functions and protocols that support communication between a SIM(s) (e.g., SIM(s) 204) and entities of supported access networks (e.g., a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 256). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In the various embodiments, Layer 2 may include a media access control (MAC) sublayer 308, a radio link control (RLC) sublayer 310, and a packet data convergence protocol (PDCP) 312 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In various embodiments, the RRC sublayer 313 may provide functions INCLUDING broadcasting system information, paging, and establishing and releasing an RRC signaling connection between the wireless device 320 and the base station 350.

In various embodiments, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some embodiments, application-specific functions provided by the at least one host layer 314 may provide an interface between the software architecture and the general purpose processing system 260.

In other embodiments, the software architecture 300 may include one or more higher logical layer (e.g., transport, session, presentation, application, etc.) that provide host layer functions. For example, in some embodiments, the software architecture 300 may include a network layer (e.g., Internet Protocol (IP) layer) in which a logical connection terminates at a packet data network (PDN) gateway (PGW). In some embodiments, the software architecture 300 may include an application layer in which a logical connection terminates at another device (e.g., end user device, server, etc.). In some embodiments, the software architecture 300 may further include in the AS 304 a hardware interface 316 between the physical layer 306 and the communication hardware (e.g., one or more radio frequency (RF) transceivers).

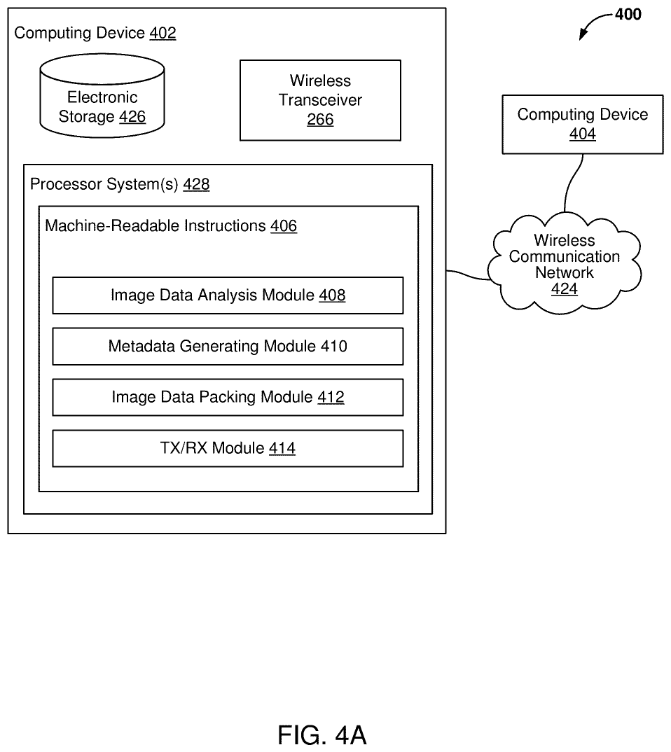

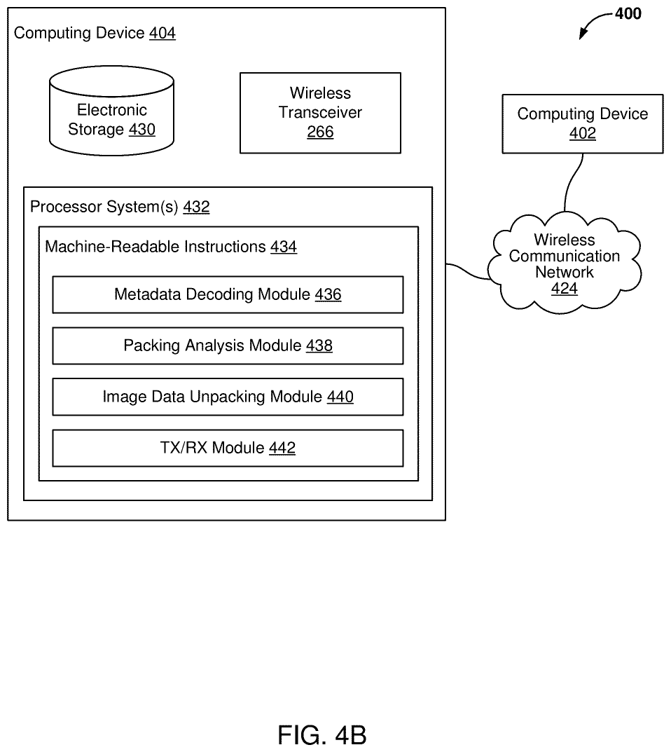

FIGS. 4A and 4B are component block diagrams illustrating a system 400 configured for image compression and image decompression accordance with various embodiments. With reference to FIGS. 1-4B, system 400 may include computing devices 402 and 404 (e.g., 110a-110d, 120a-120e, 200, 320, 350). In some embodiments computing devices 402 and 404 may be the same computing device and include all of the modules 408, 410, 412, 436, 438, 440, 442 described for each example of the computing devices 402 and 404. For example, the computing device 402 may be the computing device illustrating a configuration for image data compression and metadata encoding, and the computing device 404 may be the same computing device illustrating a concurrent and/or subsequent configuration for image data decompression and metadata decoding. Components of the computing device 402, 404, described further herein, may be the same components illustrating a concurrent and/or subsequent configurations like the computing device 402, 404. In some embodiments, computing devices 402 and 404 may be separate computing devices 402 and 404 that may communicate over a wired or wireless communication link 122, 124, 126 (aspects of which are illustrated in FIG. 1). The examples and descriptions herein may apply similarly to embodiments in which the computing device 402, 404 is a single computing device or the computing devices 402 and 404 are separate computing devices, unless otherwise indicated.

The computing devices 402, 404 may include one or more processing systems 428, 432 coupled to electronic storage 426, 430 and a wireless transceiver (e.g., 266). The wireless transceiver 266 may be configured to receive messages sent in downlink transmissions from the wireless communication network 424 and pass such message to the processing system(s) 428, 432 for processing. Similarly, the processing system(s) 428, 432 may be configured to send message for uplink transmission to the wireless transceiver 266 for transmission to the wireless communication network 424. In some embodiments, the computing device 402 may be the computing device configuration for image data compression and metadata encoding and the computing device 404 the computing device configuration for image data decompression and metadata decoding. In some embodiments, the computing device 402 may be a sending computing device and the computing device 404 may be a receiving wireless device receiving a compressed chunk of image data and related metadata.

Referring to the computing device 402, the processing system(s) 428 may be configured by machine-readable instructions 406. Machine-readable instructions 406 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The instruction modules may include one or more of an image data analysis module 408, a metadata generating module 410, an image data packing module 412, a transmit/receive (TX/RX) module 414, or other instruction modules.

The image data analysis module 408 may be configured to analyzed image data and identify locations of components of image color data (e.g., red, green, blue, and/or alpha compo, compressed and/or uncompressed, as stored in a memory (e.g., memory 220, 258, electronic storage 426). For example, the image data analysis module 408 may be configured to analyze image data and identify in which block of the image data each component of the image color data commences. In some embodiments, the image data analysis module 408 may also be configured to determine a type of packing used for a chunk of image data. For example, the image data analysis module 408 may be configured to analyze a chunk of image data and determine its compressibility.

The metadata generating module 410 may be configured to generate metadata with a location identifier configured to describe the locations of the image color data components of a portion of an image within a portion of the memory in an interleaved format. The metadata generating module 410 may generate the location identifier and encode the metadata with the location identifier. The metadata may be agnostic to image data format as the metadata may be configured to represent interleaved format image data in a manner usable by any processing system(s) 432 configured for interleaved format image data or non-interleaved format data. In some embodiments, the metadata generating module 410 may also be configured to generate metadata describing the type of packing used for the chunk of image data.

The image data packing module 412 may be configured to pack the chunk of image data according to the determined type of packing.

The transmit/receive (TX/RX) module 414 may be configured to send the packed chunk of image data and the metadata to a second computing device (e.g., the computing device 404).

Referring to the computing device 404, the processing system(s) 432 may be configured by machine-readable instructions 434. Machine-readable instructions 406 may include one or more instruction modules. The instruction modules may include computer program modules. The instruction modules may include one or more of a metadata decoding module 436, a packing analysis module 438, an image unpacking module 440, a TX/RX module 442, or other instruction modules.

The metadata decoding module 436 may be configured to decode metadata with a location identifier configured to describe the locations of the image color data components of a portion of an image within a portion of a memory (e.g., memory 220, 258, electronic storage 426) in an interleaved format. The metadata decoding module 436 may be configured to decode the location identifier and identify the locations of the image color data of the portion of the image within the portion of the memory in the interleaved format from the location identifier. In some embodiments, the metadata decoding module 436 may be configured to decode metadata describing a type of packing used for a chunk of image data.

The packing analysis module 438 may be configured to determine the type of packing used for the chunk of image data based on the decoded metadata.

The image unpacking module 440 may be configured to unpack the chunk of image data according to the determined type of packing used for the chunk of image data.

The TX/RX module 442 may be configured to enable communications with the wireless communication network 424.

In some embodiments, the computing devices 402, 404 may be operatively linked via one or more electronic communication links, such as a wired or a wireless communication link 122 or some other communication medium.

The electronic storage 426, 430 may include non-transitory storage media that electronically stores information. The electronic storage media of electronic storage 426, 430 may include one or both of system storage that is provided integrally (i.e., substantially non-removable) with the computing devices 402, 404 and/or removable storage that is removably connectable to the computing devices 402, 404 via, for example, a port (e.g., a universal serial bus (USB) port, a firewire port, etc.) or a drive (e.g., a disk drive, etc.). Electronic storage 426, 430 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 426, 430 may include one or more virtual storage resources (e.g., cloud storage, a virtual private network, and/or other virtual storage resources). Electronic storage 426, 430 may store software algorithms, information determined by processing system(s) 428, 432, information received from the computing devices 402, 404, or other information that enables the computing devices 402, 404 to function as described herein.

Processing system(s) 428, 432 may be configured to provide information processing capabilities in the computing devices 402, 404. As such, the processing system(s) 428, 432 may include one or more of a digital processor, an analog processor, a digital circuit designed to process information, an analog circuit designed to process information, a state machine, and/or other mechanisms for electronically processing information. Although the processing system(s) 428, 432 are illustrated as single entities, this is for illustrative purposes only. In some embodiments, the processing system(s) 428, 432 may include a plurality of processing units and/or processor cores. The processing units may be physically located within the same device, or processing system(s) 428, 432 may represent processing functionality of a plurality of devices operating in coordination. The processing system(s) 428, 432 may be configured to execute modules 408-414 and modules 436-442 and/or other modules by software; hardware; firmware; some combination of software, hardware, and/or firmware; and/or other mechanisms for configuring processing capabilities on processing system(s) 428, 432. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 408-414 and modules 436-442 described below is for illustrative purposes, and is not intended to be limiting, as any of modules 408-414 and modules 436-442 may provide more or less functionality than is described. For example, one or more of the modules 408-414 and modules 436-442 may be eliminated, and some or all of its functionality may be provided by other modules 408-414 and modules 436-442. As another example, the processing system(s) 428, 432 may be configured to execute one or more additional modules that may perform some or all of the functionality attributed below to one of the modules 408-414 and modules 436-442.

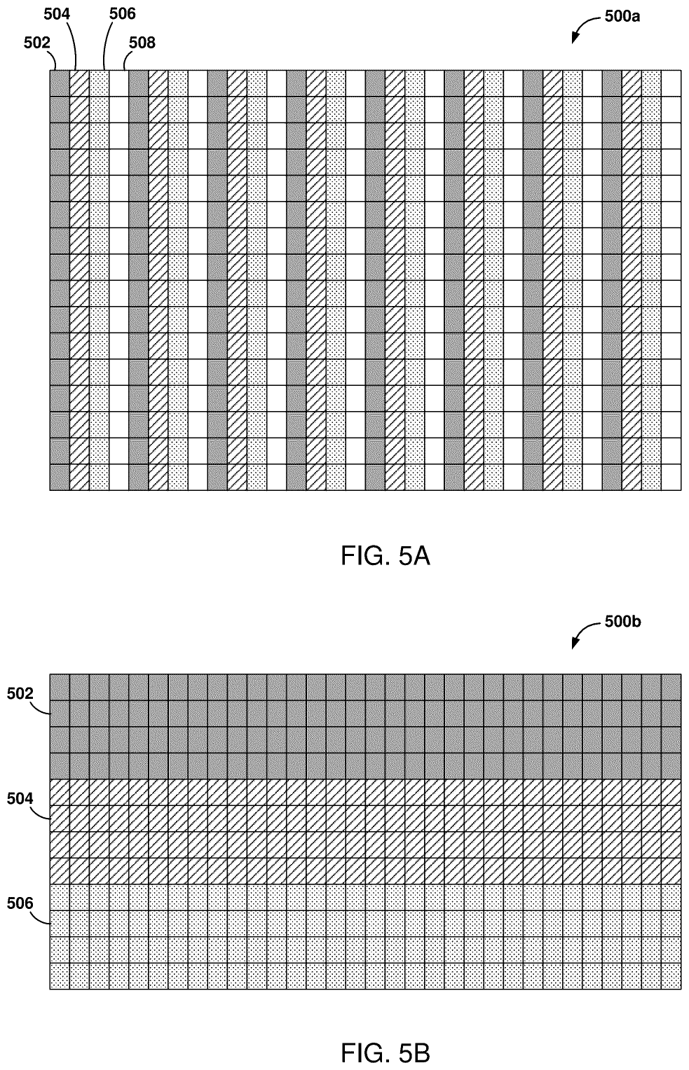

FIGS. 5A and 5B are diagrams of example image data formats 500a, 500b in a memory (e.g., memory 220, 258, electronic storage 426) in accordance with various embodiments. With reference to FIGS. 1-5A, the memory may be a component of a computing device (e.g., 110a-110d, 120a-120e, 200, 320, 350, 402, 404), such as a non-volatile and/or volatile memory, such as a local memory, scratchpad memory, cache memory, main memory, random access memory (e.g., DRAM and/or SRAM). The image data formats 500a, 500b may be representations of image data, including components of image color data, such as a red component 502, a green component 504, a blue component 506, and/or or an alpha (or transparency) component 508.

The image data format 500a may be a representation of an interleaved image data format (e.g., RGBA) in the memory. For example, each column of the image data format 500a may represent a single component of image color data 502-508. Each row of the image data format 500a may represent multiple groups of image color data each having each of the components of image color data 502-508. In various examples, a combination of contiguous locations in the image data format 500a may represent the image color data for a portion of an image, such as tile of the image. For a non-limiting example, four rows of the image data format 500a may represent the tile of the image.

The image data format 500b may be a representation of a non-interleaved image data format (e.g., RGB Planar) in the memory. For example, each section (e.g., contiguous locations in memory over contiguous rows) of the image data format 500b may represent a single component of image color data 502-506. In some examples, the image data format 500b may exclude the alpha (or transparency) component 508. In various examples, a combination of non-contiguous locations in the image data format 500b may represent the image color data for a portion of an image, such as pixel of the image. In a non-limiting example, one location within a section for each component of image color data 502-506 of the image data format 500b may represent a pixel of the image.

Various processing systems and/or processors (e.g., 210, 212, 214, 216, 218, 252, 260, 428, 432) of the computing device, may be configured for writing and/or reading a different one of the image data formats 500a, 500b at the memory and not configured to read the other of the image data formats 500a, 500b. For example, a processing system may be configured for writing and/or reading the image data format 500a at the memory and another processing system may be configured for writing and/or reading the image data format 500b at the memory. The processing system configured for the image data format 500a may not be enabled to directly write and/or read in the image data format 500b, and the processing system configured for the image data format 500b may not be enabled to directly write and/or read in the image data format 500a. To write and/or read in the image data format 500a, 500b for which the processing system is not configured, various processes may be implemented to translate/convert image data to the image data format 500a, 500b for which the processing system is configured.

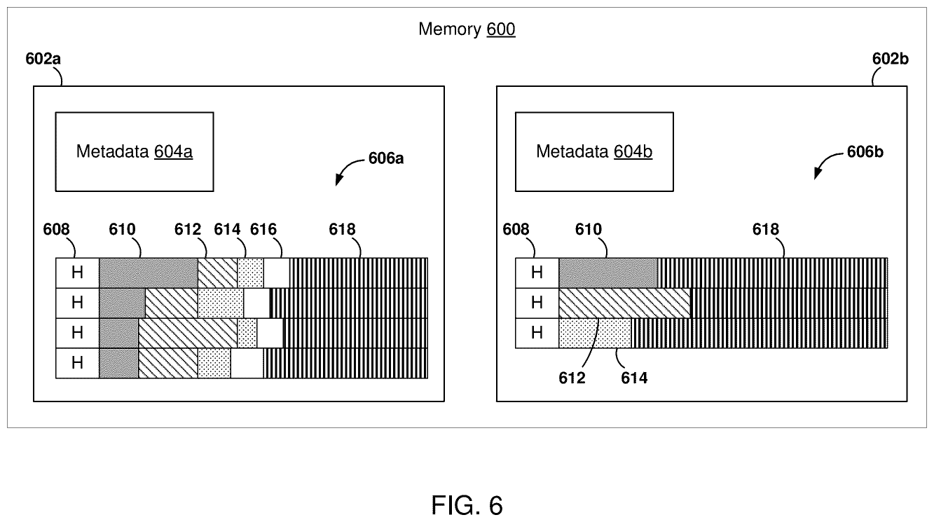

FIG. 6 is a diagram of an example of compressed image data of different image data formats (e.g., image data format 500a, 500b) in a memory 600 (e.g., memory 220, 258, electronic storage 426) in accordance with some embodiments. With reference to FIGS. 1-6, the memory 600 may be a component of a computing device (e.g., 110a-110d, 120a-120e, 200, 320, 350, 402, 404), such as a non-volatile and/or volatile memory, such as a local memory, scratchpad memory, cache memory, main memory, random access memory (e.g., DRAM and/or SRAM). The memory may be coupled with various processing systems (e.g., 210, 212, 214, 216, 218, 252, 260, 428, 432) of the computing device.

The processing systems may write and/or read image data 602a, 602b at the memory 600. In the example in FIG. 6, a processing system configured for an interleaved image data format (e.g., image data format 500a) may write and/or read the image data 602a at the memory 600. The image data 602a may be compressed and include metadata 604a and image color data 606a having headers 608 for the compressed data including components of image color data 610, 612, 614, 616, (e.g., component of image color data 502-508). The components of the image color data may include a red component 610, a green component 612, a blue component 614, and an alpha (or transparency) component 616. Compressing the image color data 606a may result in memory space savings 618.

A processing system configured for a non-interleaved image data format (e.g., image data format 500b) may not be enabled to directly write and/or read the image data 602a of the interleaved image data format at the memory 600. To write and/or read in the interleaved image data format for which the processing system is not configured, various processes may be implemented to translate/convert image data 602a to the non-interleaved image data format of the image data 602b for which the processing system is configured. The processes to translate/convert may consume additional power of a power supply (e.g., battery) of the computing and incur performance speed costs.

The image data 602a may be copied and converted to the image data 602b resulting in additional used memory space of the memory 600 and additional processes to copy and convert the image data 602a. The image data 604a may also be compressed and include metadata 604b and image color data 606b having headers 608 for the compressed data including the components of image color data 610, 612, 614, (e.g., component of image color data 502-506). The components of the image color data may include the red component 610, the green component 612, and the blue component 614. The components of the image color data may exclude the alpha (or transparency) component 616. The compressed image color data 606b may result in memory space savings 618.

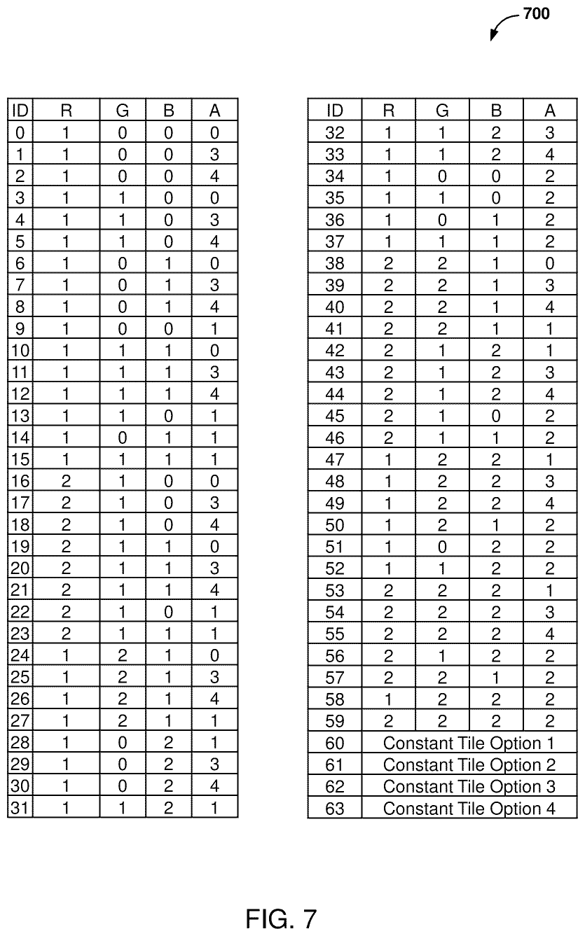

FIG. 7 is a table diagram of a mapping 700 of location identifiers of encoded metadata with values configured to represent locations of components of image color data (e.g., component of image color data 502-508, 610-616) in a memory (e.g., memory 220, 258, 600, electronic storage 426) in accordance with some embodiments. With reference to FIGS. 1-7 location identifiers (ID column in FIG. 7) may be encoded into metadata (e.g., metadata 604a) of interleaved image data format (e.g., image data format 500a). The location identifiers may be configured to describe locations of image color data (e.g., image color data 606a, component of image color data 502-508, 610-616) of a portion of an image within a portion of the memory in the interleaved format.

The location identifiers may correspond with values (red (R) component column, green (G) component column, blue (B) component column, and/or alpha (A) (or transparency) component column in FIG. 7) configured to represent locations of multiple components of the image color data of the portion of the image within the portion of the memory in the interleaved format. The values of each column of the mapping 700 may correspond to a location of the respective component of the image color data in the memory.

In the example illustrated in FIG. 7, there may be up to six values for representing the locations of each component of the image color data in the memory. A value “0” may be configured to indicate that the component of the image color data is compressed as part of a previous block in the memory. A value “1” may be configured to indicate that the component of the image color data starts a new block of a first size (e.g., 32-bytes) in the memory. A value “2” may be configured to indicate that the component of the image color data starts a new block of a second size (e.g., 64-bytes) in the memory. A value “3” may be configured to indicate that the component of the image color data includes a first constant value (e.g., “0”) in the memory. A value “4” may be configured to indicate that the component of the image color data includes a second constant value (e.g., “1”) in the memory. Additional constant option values (e.g., “Constant Option 1”, “Constant Option 2”, “Constant Option 3”, “Constant Option 4” in FIG. 7) may be configured to indicate that the component of the image color data include combinations of constant values. For example, Constant Option 1 may indicate that all of the components of the image color data may be a constant value “0” and Constant Option 2 may indicate that all of the components of the image color data may be a constant value “1.” Constant Option 3 may indicate that the red, green, and blue components of the image color data may be a constant value “1” and the alpha (or transparency) component may be a constant value “0.” Constant Option 4 may indicate that the red, green, and blue components of the image color data may be a constant value “0” and the alpha (or transparency) component may be a constant value “1.” Other combinations of the component of the image color data may be constant values.

In the example illustrated in FIG. 7, the order of the component of the image color data in the memory may start with the red component and the values for the red (R) component column may be “1” or “2”. The values for the green (G) component column and the blue (B) component column may be “0”, “1”, or “2”. The values of the alpha (A) (or transparency) component may be “0”, “1”, “2”, “3”, or “4”. The constant title option values may apply to all the component columns. The combination of possible values for the component columns may correspond to 64 identifiers.

The numbers, values, and configurations of the identifiers, values, and component columns of the example in FIG. 7 are not meant to be limiting. It will be appreciated that fewer and/or additional numbers, values, and configurations of the identifiers, values, and component columns may be similarly implemented for metadata encoding and to describe locations of image color data of a portion of an image within a portion of the memory in the interleaved format.

In some embodiments, the mapping 700 may be a data structure stored in the memory accessible by a processing system (e.g., 210, 212, 214, 216, 218, 252, 260, 428, 432). In some embodiments, the mapping 700 may be calculated in real-time by hardware, software, and/or firmware configuring a processing system.

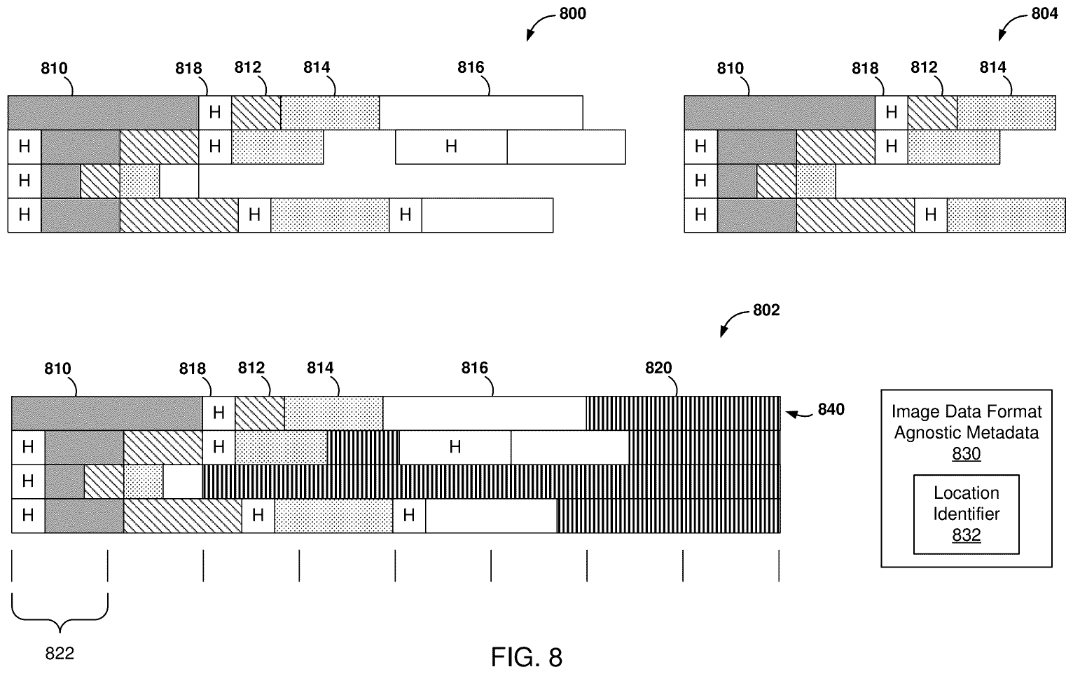

FIG. 8 is a diagram of an example of compressed image data 802 including image data format agnostic metadata 830 in a memory (e.g., memory 220, 258, 600, electronic storage 426) in accordance with some embodiments. With reference to FIGS. 1-8, the memory may be a component of a computing device (e.g., 110a-110d, 120a-120e, 200, 320, 350, 402, 404), such as a non-volatile and/or volatile memory, such as a local memory, scratchpad memory, cache memory, main memory, random access memory (e.g., DRAM and/or SRAM), etc. The memory may be coupled with various processors (e.g., 210, 212, 214, 216, 218, 252, 260, 428, 432) of the processing systems in the computing device. One processing system may be configured for interleaved image data formats (e.g., image data format 500a) and another processor may be configured for non-interleaved image data formats (e.g., image data format 500b).

The compressed image data 802 may be stored in the memory in an interleaved image data format. The compressed image data 802 may include compressed and/or not compressed components of image color data 810, 812, 814, 816 (e.g., component of image color data 502-508, 610-616). For example, the components of image color data may include red components 810, green components 812, blue components 814, and/or alpha (or transparency) components 816. Components of image color data 810, 812, 814, 816 that are compressed may be preceded in the memory by a compression header 818 that may be configured to indicate whether the components of image color data 810, 812, 814, 816 are compressed and provide data relating to the compression. The components of image color data 810, 812, 814, 816 may be written to the memory in blocks 822. In a non-limiting examples, the blocks 822 may be 32-bytes, blocks may be 64-bytes (e.g., two 32-byte blocks 822). Each image color data 840 for a portion of an image, having the components of image color data 810, 812, 814, 816, may be contained within 256-bytes (e.g., eight 32-byte blocks 822). Compressing the image color data 840, by compressing at least one of the components of image color data 810, 812, 814, 816, may result in memory space savings 820 of various sizes depending on the compression of the components of image color data 810, 812, 814, 816. The compressed image data 802 may include one or more of the image color data 840 having at least one compressed component of image color data 810, 812, 814.

The processing system configured for the interleaved image data formats may be configured to write and/or read compressed image data 802 directly to and/or from the memory. In some embodiments, the processing system may generate and compress image data generating compressed image data 800. The processing system may write the compressed image data 800 to the memory in the same configuration as the compressed image data 802 is stored at the memory. The compressed image data 802 stored at the memory may be the compressed image data 800 written to the memory by the processing device. Writing the compressed image data 800 to the memory may also include writing image data format agnostic metadata 830 having location identifiers 832 (e.g., ID column values in FIG. 7) for each compressed image color data 840 (e.g., each set of components of image color data 810, 812, 814, 816 and/or compression headers 818). The processing system may read the compressed image data 800 out of the memory in the same configuration as the compressed image data 802 is stored at the memory. The compressed image data 802 stored at the memory may be the compressed image data 800 read out of the memory by the processing device. In some embodiments, the compressed image data 800 read out of the memory may be the compressed image data 802 stored at the memory by the processing system or another processing system configured for the interleaved image data formats. Whether written to or read from the memory by the processing system, the compressed image data 800 may be the same as the image data 802 stored in the memory.

The processing system configured for the non-interleaved image data formats may be configured to write and/or read compressed image data 802 directly from the memory with the aid of metadata (e.g., image data format agnostic metadata 830) having the location identifiers 832. The processing system may decode the metadata (e.g., image data format agnostic metadata 830) and interpret the location identifiers 832, identifying the locations of the components of image color data 810, 812, 814, 816 of the compressed image data 802 in the memory. For example, a compressed image color data 840 may have a location identifier value of “16” which the processing system may decode as values “2100” as in the mapping (e.g., mapping 700) of location identifiers and values. The values “2100” may indicate to the processing system that the red component 810 is in a second sized block, the green component starts a new first sized block, and the blue component and the alpha component are compressed into the as part of a previous block in the memory. The processing system may use the locations of the components of image color data 810, 812, 814, 816 of the compressed image data 802 to read out compressed image data 804, including one or more of the components of image color data 810, 812, 814, 816, directly from the compressed image data 802. In other words, the processing system may read out the compressed image data 804 without additional processes to translate/convert the compressed image data 802 into a non-interleaved image data format.

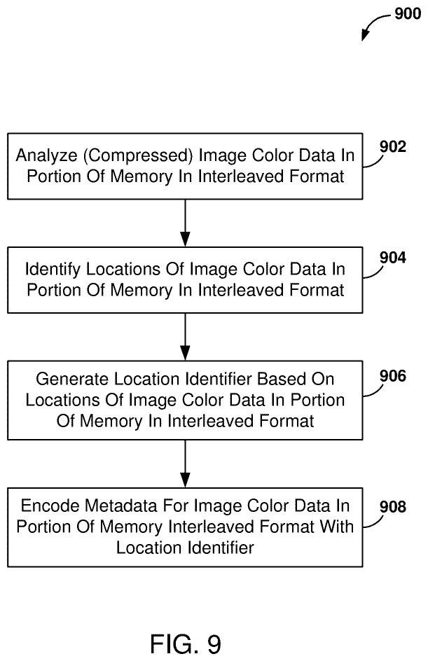

FIG. 9 is a process flow diagram illustrating a method 900 that may be performed by a processing system (e.g., 210, 212, 214, 216, 218, 252, 260, 428, 432) of a computing device (e.g., 110a-110d, 120a-120e, 200, 320, 350, 402, 404) for image compression in accordance with various embodiments. With reference to FIGS. 1-9, the method 900 may be implemented by the processing system of the computing device including a memory (e.g., memory 220, 258, 600, electronic storage 426), such as a non-volatile and/or volatile memory, such as a local memory, scratchpad memory, cache memory, main memory, random access memory (e.g., DRAM and/or SRAM), etc. In some embodiments, the method 900 may be implemented by the processing system executing one or more modules (e.g., image data analysis module 408, metadata generating module 410). In some embodiments, the processing system implementing the method 900 may be configured for interleaved image data formats. Means for performing functions of the operations in the method 900 may include the processing system (e.g., 210, 212, 214, 216, 218, 252, 260, 428, 432) and/or the modules (e.g., image data analysis module 408, metadata generating module 410).

In block 902, the processing system may analyze image color data (e.g., image color data 840) stored at a portion of the memory in an interleaved image data format (e.g., image data format 500a). Analyzing the image color data may include identifying aspects of the image color data, such as location of the image data, including image color data, in the memory, image data format, such as interleaved and/or non-interleaved image data formats, whether the image data, including image color data, is compressed, type of compression, etc.

In block 904, the processing system may identify locations of the components of the image color data (e.g., component of image color data 502-508, 610-616, 810-816) in the memory. For example, locations may be identified based on which blocks (e.g., block 822) of the image color data the components of the image color data start.

In block 906, the processing system may generate a location identifier (e.g., values of ID column in FIG. 7) based on the locations of the components of the image color data in the memory. The locations of the components of the image color data in the memory may be specific to absolute locations within the memory and/or relative to locations of other components of the image color data in the memory. In some embodiments, the locations of the components of the image color data in the memory may be specific block locations in the memory containing at least a portion of a component of the image color data. In some embodiments, the locations of the components of the image color data in the memory may be relative block locations in the memory to other block locations in the memory containing at least a portion of a component of the image color data.

The processing system may be configured to correlate and/or represent the locations of the components of the image color data in the memory to representative values (e.g., values of the red (R) component column, green (G) component column, blue (B) component column, and/or alpha (A) (or transparency) component column in FIG. 7). Based on one or more of the representative values of the locations of the components of the image color data in the memory, the processing system may be configured to generate the location identifier. In some embodiments, the processing system may look up the one or more of the representative values of the locations of the components of the image color data in a data structure (e.g., mapping 700 in FIG. 7) and locate the corresponding location identifier. In some embodiments, the processing system may algorithmically generate the location identifier using one or more of the representative values of the locations of the components of the image color data as inputs to a software and/or hardware algorithm.

In block 908, the processing system may encode metadata for the image color data stored at the portion of the memory in the interleaved image data format with the location identifier (e.g., location identifier 832). In some embodiments, in block 908 the processing system may encode metadata as image data format agnostic metadata (e.g., 830). The processing system may write the location identifier for each image color data to a metadata for the respective image color data.

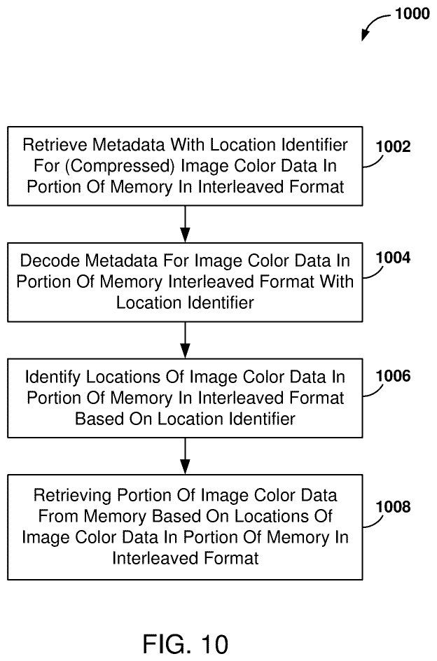

FIG. 10 is a process flow diagram illustrating a method 1000 that may be performed by a processing system (e.g., 210, 212, 214, 216, 218, 252, 260, 428, 432) of a computing device (e.g., 110a-110d, 120a-120e, 200, 320, 350, 402, 404) for image decompression in accordance with various embodiments. With reference to FIGS. 1-10, the method 1000 may be implemented by the processing system of the computing device including a memory (e.g., memory 220, 258, 600, electronic storage 426), such as a non-volatile and/or volatile memory, such as a local memory, scratchpad memory, cache memory, main memory, random access memory (e.g., DRAM and/or SRAM), etc. In some embodiments, the method 1000 may be implemented by the processing system executing one or more modules (e.g., metadata decoding module 436). In some embodiments, the processing system implementing the method 1000 may be configured for non-interleaved image data formats and may be a different processing system that may implement the method 900. Means for performing functions of the operations in the method 1000 may include the processing system (e.g., 210, 212, 214, 216, 218, 252, 260, 428, 432) and/or the modules (e.g., metadata decoding module 436).

In block 1002, retrieve metadata (e.g., image data format agnostic metadata 830) with a location identifier (e.g., location identifier 832) for image color data (e.g., image color data 840) stored at a portion of the memory in an interleaved image data format (e.g., image data format 500a). As part of a data access of the memory for the image color data, the processing system may retrieve and read the metadata with the location identifier associated with the image color data. The metadata with the location identifier may also be stored in the memory in which the image color data is stored.

In block 1004, the processing system may decode the metadata with the location identifier for the image color data stored at the portion of the memory in the interleaved image data format. The processing system may be configured to correlate and/or represent locations of the components of the image color data (e.g., component of image color data 502-508, 610-616, 810-816) in the memory to representative values (e.g., values of the red (R) component column, green (G) component column, blue (B) component column, and/or alpha (A) (or transparency) component column in FIG. 7). Based on the location identifier for the image color data, the processing system may be configured to generate and/or identify one or more of the representative values of the locations of the components of the image color data in the memory. In some embodiments, the processing system may look up the location identifier (e.g., values of ID column in FIG. 7) in a data structure (e.g., mapping 700 in FIG. 7) and locate the corresponding one or more of the representative values of the locations of the components of the image color data. In some embodiments, the processing system may algorithmically generate the one or more of the representative values of the locations of the components of the image color data using the location identifier as an input to a software and/or hardware algorithm.

In block 1006, the processing system may identify locations of the image color data stored at the portion of the memory in interleaved image data format based on the location identifier. Using one or more of the representative values of the locations of the components of the image color data in the memory that the processing system derived from the location identifier, the processing system may be configured to locate the components of the image color data in the memory. The locations of the components of the image color data in the memory may be specific to absolute locations within the memory and/or relative to locations of other components of the image color data in the memory. In some embodiments, the locations of the components of the image color data in the memory may be specific block locations in the memory containing at least a portion of a component of the image color data. In some embodiments, the locations of the components of the image color data in the memory may be relative block locations in the memory to other block locations in the memory containing at least a portion of a component of the image color data. The processing system may use the representative values of the locations of the components of the image color data in the memory to identify the block locations for the components of the image color data in the memory.

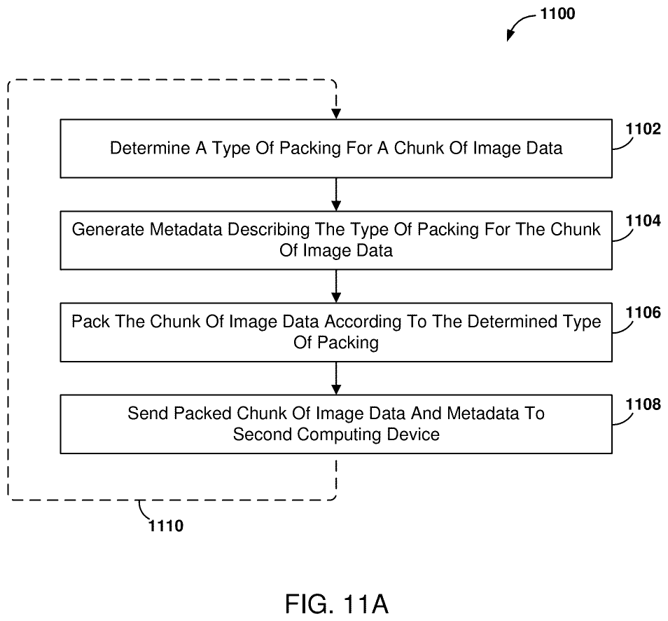

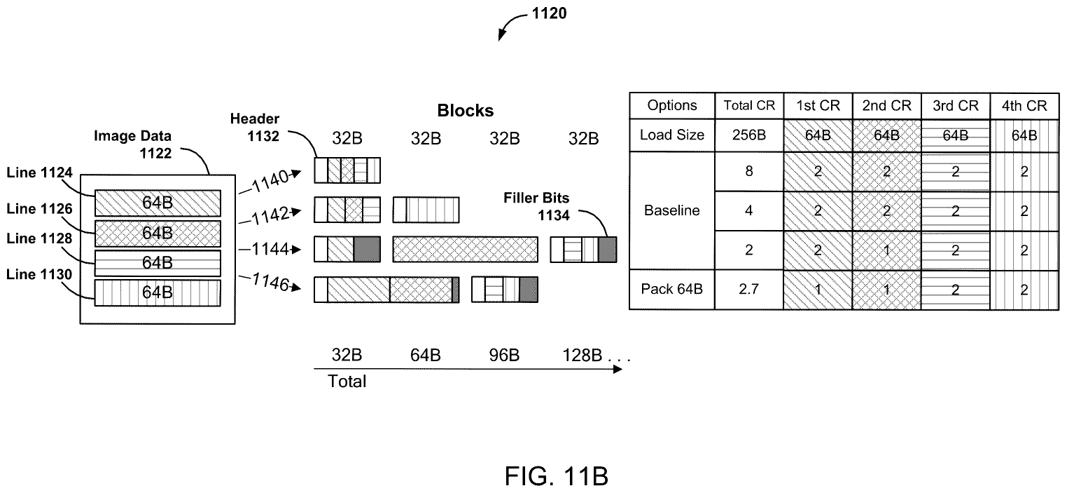

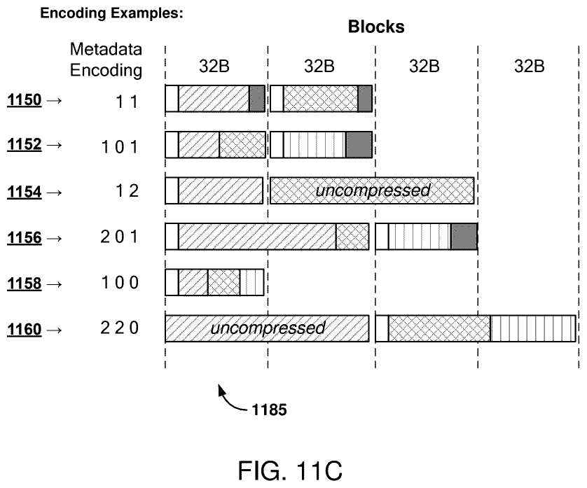

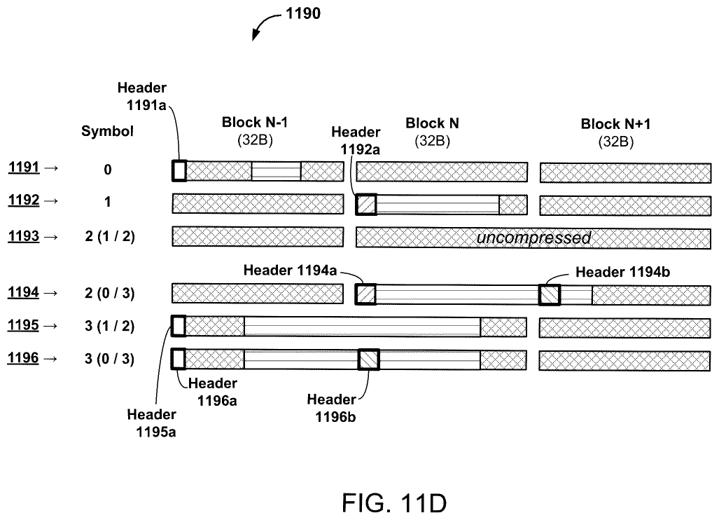

In block 1008, the processing system may retrieve at least a portion of the image color data from the memory based on the locations of the image color data stored at the portion of the memory in interleaved image data format. The processing system may be configured, such as by software and/or hardware, to retrieve one or more components of the image color data. Using the locations of the components of the image color data, the processing system may retrieve the one or more components of the image color data directly from the FIG. 11A is a process flow diagram illustrating a method 1100 that may be performed by one or more processors within a processing system of a computing device for image compression according to various embodiments. With reference to FIGS. 1-11A, the method 1100 may be implemented by a processor (e.g., 210, 212, 214, 216, 218, 252, 260, 428, 432) within a processing system of a computing device. Means for performing functions of the operations in the method 1100 may include the processing system (e.g., 210, 212, 214, 216, 218, 252, 260, 428, 432) and/or the modules (e.g., metadata decoding module 436).

In block 1102, the processing system may determine a type of data compression or packing to use for a chunk of image data. In some embodiments, the processor may analyze the chunk of image data to determine its compressibility, and determine a type of packing suitable for the chunk of image data based on its compressibility.

In block 1104, the processing system may generate metadata describing the packing that will be applied to the chunk of image data. The metadata may include information indicating the location of one or more blocks and/or the location of chunk data in or across one or more blocks. In some embodiments, the metadata describing the type of packing used for the chunk of image data may enable the chunk of image data to be read independently of a second chunk of image data. In some embodiments, the metadata describing the type of packing used for the chunk of image data may enable the chunk of image data to be written tiled and read linearly. In some embodiments, generating the metadata describing the type of packing used for the chunk of image data may include generating metadata indicating whether the chunk of image data is compressed or uncompressed.

In block 1106, the processing system may pack the chunk of image data according to the determined type of packing. In some embodiments, packing the chunk of image data may include packing two or more chunks of image data according to the determined type of packing.

In block 1108, the processing system may send the packed chunk of image data and the metadata to a second computing device. In some embodiments, the processor may send the packed two or more chunks of image data and the metadata to the second computing device.

In operation 1110, the processing system may repeat the operations of blocks 1102-1108 to process multiple chunks of image data.

FIG. 11B is conceptual block diagram illustrating image data compression schema 1120 in accordance with various embodiments. With reference to FIGS. 1-11B, the image data compression schema 1120 may be implemented by a processor (e.g., 210, 212, 214, 216, 218, 252, 260, 428, 432) of a computing device (e.g., the wireless devices 120a-120e, 200, 320, 402, 404).

Image data 1122 may include lines 1124, 1126, 1128, and 1130. Each of lines 1124-1130 may include 64 bytes of data. In some embodiments, the processing system may compress each of lines 1124, 1126, 1128, and 1130 individually and may store each compressed line in a 32-byte block or a 64-byte block aligned to 32 bytes.

The processing system may compress the image data according to one or more examples 1120 of image data compression. As illustrated in example 1140, the processing system may compress the four lines 1124-1130 into a 32-byte block. As illustrated in example 1142, the processing system may compress three lines (e.g., lines 1124-1128 in example 1142) into a 32-byte block and may compress one line (e.g., line 1130 in example 1142) into another 32-byte block.

As illustrated in example 1144, the processing system may bridge one line (e.g., line 1126) across two 32-byte blocks. As illustrated in examples 1144 and 1146, the processor may compress two lines into one 32-byte block (e.g., lines 1128 and 1130 in examples 1144 and 1146). As illustrated in example 1146, the processing system may bridge a line from one 32-byte block to another 32-byte block (i.e., two lines in 64 bytes, or “Pack 64B”). In various embodiments, the processing system may include a header 1132 at the beginning of at least one block as further described below. In some embodiments, the processing system may add filler bits 1134 to fill out a 32-byte block.

The accompanying table illustrates a compression ratio (CR) that may be achieved for each line 1124-1130. The table includes example data sizes for the image data 1142 (256B) and for each of lines 1124-1130 (64B). The table also includes compression ratios for the image data 1142 (Total CR) and compression rations for each line 1124-1130 (1st CR, 2nd CR, 3rd CR, 4th CR) using a “baseline” compression or using “Pack 64B.” For a baseline compression with a compression ratio of 8:1 (8), the lines 1124-1130 may be compressed into one 32-byte block, as in example 1140. The effective compression ratio for each line 1124-1130 may be 2:1 (2) because a 32-byte block may be retrieved from memory having the 64-byte line 1124-1130. For a baseline compression with a compression ratio of 4:1 (4), the lines 1124-1130 may be compressed into two 32-byte blocks, as in example 1142. The effective compression ratio for each line 1124-1130 may be 2:1 (2) because a 32-byte block may be retrieved from memory having the 64-byte line 1124-1130. For a baseline compression with a compression ratio of 2:1 (2), the lines 1124-1130 may be compressed into four 32-byte blocks, as in example 1144. The effective compression ratio for each line 1124, 1128, 1130 compressed into a 32-byte block may be 2:1 (2) because a 32-byte block may be retrieved from memory having the 64-byte line 1124, 1128, 1130. The effective compression ratio for each line 1126 bridging across two 32-byte blocks may be 1:1 (1) because a 64-byte block (or two 32-byte blocks) may be retrieved from memory having the 64-byte line 1126. For Pack 64B compression with a compression ratio of 2.7:1 (2.7), the lines 1124-1130 may be compressed into three 32-byte blocks, as in example 1146. The effective compression ratio for each line 1124, 1126 bridging across two 32-byte blocks may be 1:1 (1) because a 64-byte block (or two 32-byte blocks) may be retrieved from memory having the 64-byte line 1124, 1126. The effective compression ratio for each line 1128, 1130 compressed into a 32-byte block may be 2:1 (2) because a 32-byte block may be retrieved from memory having the 64-byte line 1128, 1130.

FIG. 11C is conceptual block diagram illustrating metadata encodings 1185, in accordance with various embodiments. With reference to FIGS. 1-11C, the metadata encodings 1185 may be implemented by a processing system (e.g., 210, 212, 214, 216, 218, 252, 260, 428, 432) of a computing device (e.g., the wireless devices 120a-120e, 200, 320, 402, 404).

To enable random access to image data, the location and size of each 64-byte chunk may be described in the metadata. In some embodiments, each 64-byte chunk may be read from a 32-byte block or two 32-byte blocks totaling 64 bytes (sometimes referred to as a 64-byte block). In some embodiments, the processing system may prioritize compressing a chunk into a 32-byte block, which may improve efficiency and performance of compression and decompression operations. In some embodiments, if more than one 64-byte chunk is compressed into the same block, compression headers must be provided for each chunk. In some embodiments, a 64-byte chunk when compressed may fit in a previous block (which may be signified by “0”), begin a 32-byte compressed block (which may be signified by “1”), or begin a 64-byte compressed block (which may be signified by “2”).

In some embodiments, a metadata encoding scheme may include two states for an initial chunk (encoded by 1 bit) and three states for additional chunks (encoded by more than 1 bit and less than or equal to 2 bits). For example, for four chunks, metadata may encode for 54 states (i.e., 2*3*3*3 states) that may be encoded in 6 bits (or in 7 bits if kept separate, i.e., 1+2+2+2 bits). In various embodiments, the metadata encoding scheme may be generalized to more or fewer chunks.

In some embodiments, the first 64-byte chunk may start at the beginning of a block and cannot be compressed to correspond with a value “0”. In some embodiments, two lines may share a 64-byte block if compression is insufficient to overcome line overheads caused by their separation into two 32-byte blocks. In such embodiments, a “0” metadata encoding may not follow a “2” metadata encoding, resulting in 34 possible states. In some embodiments, bridging options may be indicated by a “3” metadata encoding (i.e., a “3” value may indicate that chuck is bridged, or continues, from a previous block). In some embodiments, bridging options may be fully described using 7 bits. In some embodiments, the metadata encoding scheme may be generalized to encode higher order states, such as overlapping more than two tiles.

Metadata encodings 1150-1160 illustrate non-limiting examples of such information encoded in the metadata. Metadata encoding 1150 “1 1” signifies that two chunks each start at the beginning of a 32-byte block. Metadata encoding 1152 “1 0 1” signifies the start of a 32-byte compressed block, followed by a 64-byte chunk fit into the 32-byte block, followed by the start of another 32-byte compressed block. Metadata encoding 1154 “1 2” signifies the start of a 32-byte compressed block, followed by the start of a 64-byte block, in this example, of uncompressed image data. Metadata encoding 1156 “2 0 1” signifies the start of a 64-byte compressed block, followed by a 64-byte chunk that fits into the second 32-byte block, followed by a 32-byte compressed block. Metadata encoding 1158 “1 0 0” signifies the start of a 32-byte compressed block, followed by a 64-byte chunk that fits into the same 32-byte block, followed by a second 64-byte chunk that fits into the same 32-byte block. Metadata encoding 1160 represents a special case, in which “2 2 0” signifies the start of a 64-byte uncompressed block, followed by the start of a 64-byte uncompressed block, followed by a 64-byte chunk is fit into the second 64-byte block. In metadata encoding 1160, the first “2” value is not followed by an indication that it shares a block with another chunk, and in some embodiments, this may signify the presence of uncompressed image data.

In some embodiments, the processing system may split a 64-byte chunk across two 32-byte blocks (i.e., “bridging” or “overlap” between or across two 32-byte blocks). For example, if a line of data (e.g., the lines 1124-1130) requires greater than 32 bytes when compressed (e.g., 64 bytes), the processing system may compress a first part of the line in a 32-byte block and the remainder of the line in a subsequent 32-byte block. Further, in some embodiments, overlaps or bridging of chunks across blocks may continue serially, such that a first line may be packed into a first 32 byte block and a portion of a second 32 byte block; a second line may be packed into the remainder of the second 32 byte block and a portion of a third 32 byte block, and so forth. Various embodiments may be implemented to prioritize 64-byte compression and/or 256-byte compression, which the processing system may perform dynamically or statically according to the implementation. To save space, the processing system may omit a header where a 32B compression could otherwise be separately decoded. In some embodiments, the processing system may dynamically determine to compress a chunk within 32 bytes, or to bridge the chunk over two 32-byte blocks each with another compressed block that may fit within the remainder of each 32-byte block. In some embodiments, the processing system may be configured to dynamically determine chunk compression in this manner universally for an implementation, for example favoring full compression access over individually accessed compression. In some embodiments, the processing system may be configured to dynamically determine chunk compression based on a buffer size (i.e., buffer capacity) or buffer utilization (i.e., an amount of data stored in a buffer), or for a particular use case. In some embodiments, the processing system may be configured to dynamically determine chunk compression to meet a compressibility target. For example, the processing system may be configured to enable to ensure a certain balance in compressibility, such as a minimum compressibility for full tiles. The example illustrated in FIG. 11C are not exhaustive and other forms of metadata encoding are possible in various embodiments.

FIG. 11D is conceptual block diagram illustrating metadata encodings 1190 in accordance with some embodiments. With reference to FIGS. 1-11D, the metadata encodings 1190 may be implemented by a processing system.

The metadata may include information describing the type of packing used for the chunk of image data into three blocks, N−1, N, and N+1. Block N−1 may correspond to a last block in which a previous chunk is placed, and block N may correspond to a next unused block. In some embodiments, packing (e.g., positions of chunks) may be constructed progressively from a first chunk to a last chunk. In some embodiments, packing may be constructed progressively. In some embodiments, packing may be calculated in parallel. In some embodiments, packing may be constructed progressively. In some embodiments, packing may be precomputed and looked up in parallel.

In some embodiments, the information may be encoded in the metadata using a single bit, or a combination of bits or bit values, or any other suitable encoding of the information. In some embodiments, symbols concatenate together to form a full encoding. In some embodiments, for each symbol, block N may be the next unfilled block. For example, metadata encoding 1191 “0” may signify that a 64-byte chunk is fit into a block, such as into block N−1. Metadata encoding 1192 “1” (e.g., in header 1192a) may signify the start of a new chunk in a 32-byte compressed block. Metadata encoding 1193 “2” followed by a “1” or a “2” encoded chunk (illustrated as “1/2”) may signify an uncompressed 64-byte chunk in 64 bytes. In such embodiments, the end of the tile may consider the “next symbol” to be 1 or 2. As another example, metadata encoding 1194 “2” followed by a “0” or a “3” encoded chunk (illustrated as “0/3”) (e.g., in a new header 1194a) may signify the start of a new compressed chunk in 64 bytes. In some embodiments, a new header (e.g., 1192a, 1194a) may reflect a type of compression, and may encode necessary information for beginning a new compressed block, and encoding information governing a new chunk. For example, the header 1192a, 1194a may signify a start header. Metadata encoding 1195 “3” followed by a “1” or “2” encoded chunk may signify a bridging chunk packed into a previous block (such as block N−1) and/or that a chunk extends (or overlaps) from a previous block. Metadata encoding 1196 “3” followed by “0” or “3” encoded chunk also may signify a bridging chunk packed into a previous block (such as block N−1).

A header 1191a, 1195a, 1196a may indicate that a new chunk is governed by a previous header (i.e., information about the chunk may be found in an earlier header). For example, the header may encode information about the next chunk (in addition to previous chunks) or may encode an offset indicating a location where more information for that chunk is located, or any combination thereof. In some embodiments, an optional header 1194b, 1196b may be inserted following a “0” chunk. In some embodiments, the header 1194b, 1196b may include a header inserted at the start of a block but interrupting the compressed information of an encoded chunk that spans from a previous block to a block in which the header 1194b, 1196b is inserted. The header 1194b, 1196b, may be optional when there is no following chunk. In some embodiments, if there is any number of following “0” blocks not followed by a “3” block then these headers may also be omitted. In that case decoding of these “0” blocks can only occur when the two blocks are available rather than just one. In some embodiments, the presence of the optional header 1194b, 1196b may indicate that each block may be read and decoded separately. Without the optional header 1194b, 1196b, the following “0” block may require reading both blocks to decode. In some embodiments, for a “3” chunk, the optional header 1194b, 1196b may be omitted if there is no following chunk (e.g., the chunk is the last chunk in a tile).

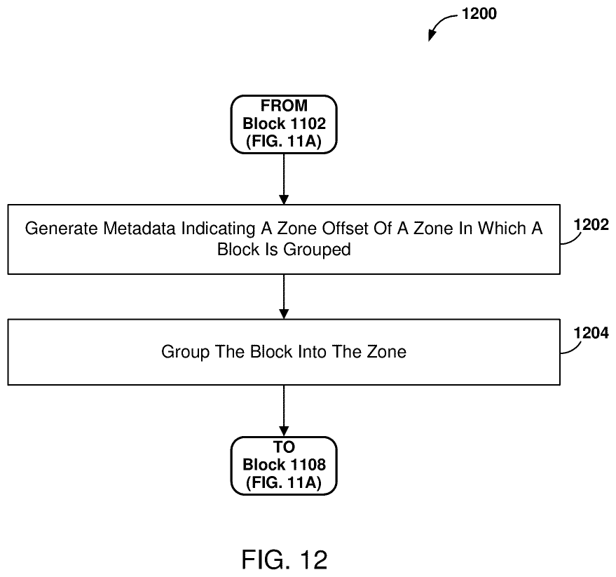

FIG. 12 is a process flow diagram illustrating operations 1200 that may be performed by a processing system of a computing device as part of the method 1100 for image compression according to various embodiments. With reference to FIGS. 1-12, the operations 1200 and the method 1100 may be implemented by a processor (e.g., 210, 212, 214, 216, 218, 252, 260, 428, 432) of processing system of a computing device (e.g., the wireless devices 120a-120e, 200, 320, 402, 404). Means for performing functions of the operations in block 1202 may include the processor (e.g., 210, 212, 214, 216, 218, 252, 260, 428, 432).

Image data may be compressed and stored in a memory. A portion of the memory in which compressed image data is stored may be referred to as a zone. For example, a zone may be one or more blocks of the memory (e.g., a 32-byte, 64-byte, etc. portion of the memory) in which the compressed image data may be stored. Compressed image data of a zone may be stored in one block, bridging two blocks, or within multiple blocks. Following performance of the operations of block 1102 of the method 1100, the processing system may generate metadata indicating a zone offset of a zone in which a block is grouped in block 1202. In some embodiments, the processing system may generate metadata indicating a zone size of a zone in which a block is grouped. In some embodiments, the processing system may generate metadata indicating a block offset of the one or more blocks in a zone. In some embodiments, the processing system may generate metadata indicating a number of blocks in a zone. In some embodiments, the processing system may generate metadata indicating a location of a header in a zone. In some embodiments, the processing system may generate metadata indicating that a block header includes an offset field.

In block 1204, the processor may pack the chunk of image data according to the determined type of packing by grouping the block into the zone.

The processor may then perform the operations of block 1108 of the method 1100 as described.

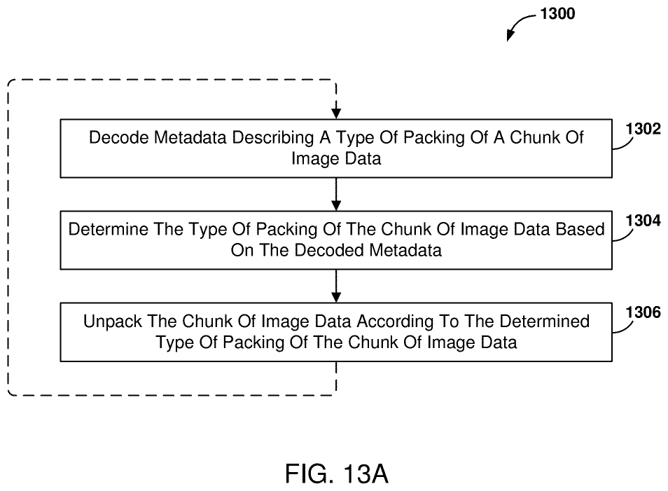

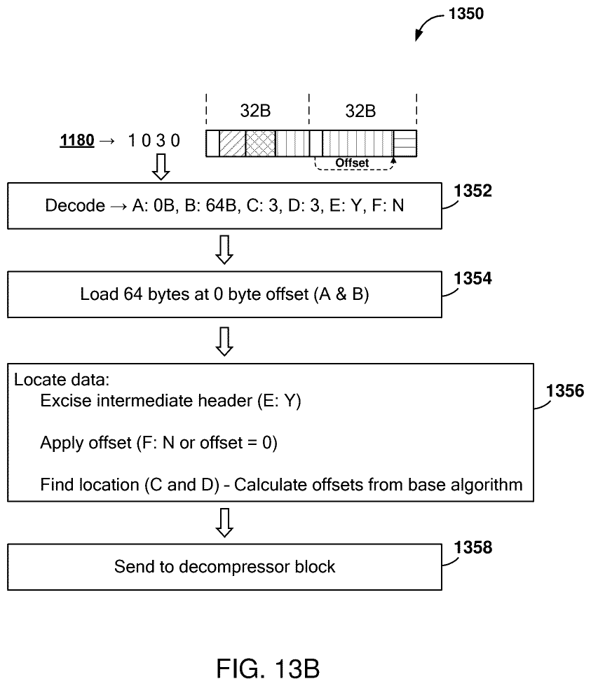

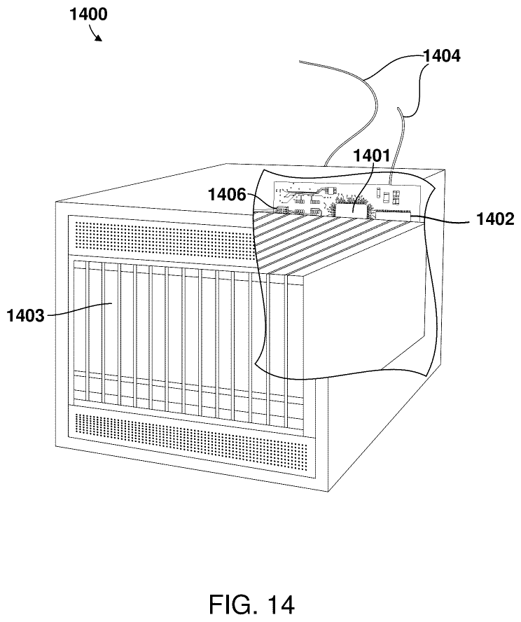

FIG. 13A is a process flow diagram illustrating a method 1300 that may be performed by a processing system of a computing device for image decompression according to various embodiments. With reference to FIGS. 1-13A, the method 1300 may be implemented by a processor (e.g., 210, 212, 214, 216, 218, 252, 260, 428, 432) processing system of a computing device (e.g., the wireless devices 120a-120e, 200, 320, 402, 404). Means for performing functions of the operations in the method 1300 may include the processor (e.g., 210, 212, 214, 216, 218, 252, 260, 428, 432).

In block 1302, the processing system may decode metadata describing the type of packing used for a chunk of image data.

In block 1304, the processing system may determine the type of packing used for the chunk of image data based on the decoded metadata. In some embodiments, the processing system may identify a block in which the chunk of image data is packed. In some embodiments, the processing system may identify a zone including the block in which the chunk of image data is packed. In some embodiments, the processing system may identify a zone offset or zone size. In some embodiments, the processing system may identify a block offset of the block in the zone. In some embodiments, the processing system may identify a number of blocks in the zone. In some embodiments, the processing system may identify a location of a block header in the zone. In some embodiments, the processing system may identify that a block header includes an offset field. Means for performing functions of the operations in block 1304 may include the processor (e.g., 210, 212, 214, 216, 218, 252, 260, 428, 432).

In block 1306, the processing system may unpack the chunk of image data according to the determined type of packing used for the chunk of image data. In some embodiments, the processing system may read the chunk of image data independently of a second chunk of image data. In some embodiments, the processor may read the chunk of image data linearly where the chunk of image data was written tiled.

The processing system may repeat the operations of blocks 1302-1306 to process multiple chunks of image data.

FIG. 13B is a conceptual block diagram illustrating an example of image decompression operations 1350 in accordance with various embodiments. With reference to FIGS. 1-13B, the operations 1350 may be implemented by a processor (e.g., 210, 212, 214, 216, 218, 252, 260, 428, 432) processing system of a computing device (e.g., the wireless devices 120a-120e, 200, 320, 402, 404).

In various embodiments, a receiving computing device may receive a compressed chunk of image data and associated metadata (e.g., 1185).

In operation 1352, the processing system of the receiving computing device may decode the metadata describing the type of packing used for the chunk of image data. In some embodiments, the metadata may be included in the compressed tile. For example, the processing system may determine from the metadata a zone offset (e.g., field A: 0 bytes), a zone size (e.g., field B: 64 bytes), a block offset in the zone (e.g., field C: 3), a number of blocks in the zone header (e.g., field D: 3), whether there is a header inserted at the 32 byte mark in a 64 byte zone (e.g., field E: (Y)es or (N)o), and whether the header for this block includes an offset field (e.g., field F: (Y)es or (N)o). In some embodiments, block offset in the zone (e.g., field C) and the number of blocks in the zone header (e.g., field D) may be encoded or placed into the compressed tile. In some embodiments, the presence of an offset (e.g., field F: Y) may indicate that a first chunk in a block (i.e., a chunk not overhanging or continuing from a previous block) begins at an offset (to account for the overhang or continuation). In this example, the third chunk is a block that overhangs, and a previous chunk does not overhang, so field F may indicate No for the third chunk, and field F may indicate Yes for a fourth chunk.

In operation 1354, the processing system may load an indicated zone. For example, fields A and B may indicate which zone of memory to load (e.g., one 64B block) or to access (e.g., all blocks).

In operation 1356, the processing system may locate block information in the zone. In some embodiments, such block information may include the block offset in the zone (e.g., field C) and the number of blocks in the zone header (e.g., field D), and may be encoded or placed into the compressed tile. For example, fields C and D may indicate a location for data of the indicated block in the zone. In some embodiments, a total number allows for header data to be packed at the start of the zone. In some embodiments, fields E and F may indicate bridging of one or more chunks. In some embodiments, an offset value may be determined based on a value in the header and/or intermediate header.

In operation 1358, the processing system may send image data and the related metadata to a decompressor block (or to any suitable function of the computing device) for unpacking according to the determined type of packing used for the chunk of image data.

Various embodiments, including the methods and operations 900, 1000, 1100, 1120, 1185, 1200, 1300, and 1350, may be performed in a variety of network computing devices, an example of which is illustrated in FIG. 14 that is a component block diagram of a network computing device 1400 suitable for use with various embodiments. Such network computing devices may include at least the components illustrated in FIG. 14. With reference to FIGS. 1-14, a network computing device 1400 may include a processing system 1401 coupled to volatile memory 1402 (e.g., 426) and a large capacity nonvolatile memory, such as a disk drive 1403. The network computing device 1400 may also include a peripheral memory access device such as a floppy disc drive, compact disc (CD) or digital video disc (DVD) drive 1406 coupled to the processing system 1401. The network computing device 1400 may also include network access ports 1404 (or interfaces) coupled to the processor 1401 for establishing data connections with a network, such as the Internet and/or a local area network coupled to other system computers and servers. The network computing device 1400 may be connected to one or more antennas for sending and receiving electromagnetic radiation that may be connected to a wireless communication link. The network computing device 1400 may include additional access ports, such as USB, Firewire, Thunderbolt, and the like for coupling to peripherals, external memory, or other devices.

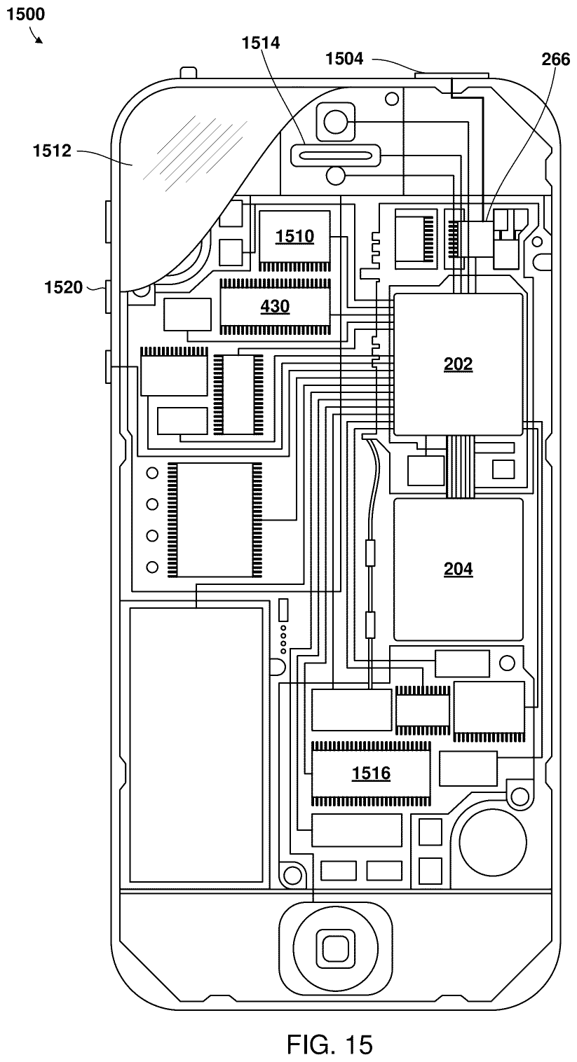

Various embodiments, including the methods and operations 900, 1000, 1100, 1120, 1185, 1200, 1300, and 1350, may be performed in a variety of wireless devices (e.g., the wireless device 120a-120e, 200, 320, 402, 404), an example of which is illustrated in FIG. 15 that is a component block diagram of a wireless device 1500 suitable for use with various embodiments. With reference to FIGS. 1-15, a wireless device 1500 may include a first SOC 202 (e.g., a SOC-CPU) coupled to a second SOC 204 (e.g., a 5G capable SOC). The first and second SOCs 202, 204 may be coupled to internal memory 426, 430, 1516, a display 1512, and to a speaker 1514. Additionally, the wireless device 1500 may include an antenna 1504 for sending and receiving electromagnetic radiation that may be connected to a wireless data link and/or cellular telephone transceiver 266 coupled to one or more processors in the first and/or second SOCs 202, 204. The wireless device 1500 may also include menu selection buttons or rocker switches 1520 for receiving user inputs.

The wireless device 1500 also may include a sound encoding/decoding (CODEC) circuit 1510, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 1510 may include a digital signal processor (DSP) circuit (not shown separately).

The processors of the network computing device 1500 and the wireless device 1500 may be any programmable microprocessor, microcomputer or multiple processor chip or chips that can be configured by software instructions (applications) to perform a variety of functions, including the functions of the various embodiments described below. In some wireless devices, multiple processors may be provided, such as one processor within an SOC 204 dedicated to wireless communication functions and one processor within an SOC 202 dedicated to running other applications. Software applications may be stored in the memory 426, 430, 1516 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 900, 1000, 1100, 1120, 1185, 1200, 1300, and 1350 may be substituted for or combined with one or more operations of the methods 900, 1000, 1100, 1120, 1185, 1200, 1300, and 1350.

Implementation examples are described in the following paragraphs. While some of the following implementation examples are described in terms of example methods, further example implementations may include: the example methods discussed in the following paragraphs implemented by a computing device comprising a processing system configured with processing system-executable instructions to perform operations of the methods of the following implementation examples; the example methods discussed in the following paragraphs implemented by a computing device comprising means for performing functions of the methods of the following implementation examples; and the example methods discussed in the following paragraphs may be implemented as a non-transitory processing system-readable storage medium having stored thereon processing system-executable instructions configured to cause a processing system of a computing device to perform the operations of the methods of the following implementation examples.

Example 1. A method performed by a processing system of a computing device for image compression, including: identifying locations of image color data of a portion of an image within a portion of a memory in an interleaved format; and encoding a metadata with a location identifier configured to describe the locations of the image color data of the portion of the image within the portion of the memory in the interleaved format.

Example 2, the method of example 1, in which encoding the metadata with the location identifier comprises encoding image data format agnostic metadata.

Example 3. The method of either of examples 1 or 2, further including generating the location identifier based on the locations of the image color data of the portion of the image within the portion of the memory in the interleaved format.

Example 4. The method of any of examples 1-3, in which the location identifier is configured to indicate to an image decoder device that a component of the image color data is one of compressed as part of a previous block, begins a first sized block, begins a second sized block, is a first constant value, or is a second constant value.

Example 5. The method of any of examples 1-4, in which the location identifier is configured to indicate to an image decoder device that all components of the image color data are a constant value.

Example 6. The method of any of examples 1-5, in which the location identifier is configured to indicate to an image decoder device that a beginning component of the image color data is one of begins a first sized block, begins a second sized block, is a first constant value, or is a second constant value.

Example 7. The method of any of examples 1-6, in which the image color data of the portion of the image within the portion of the memory in the interleaved format includes compressed image color data for at least one component of the image color data.

Example 8. The method of any of examples 1-7, in which the image color data of the portion of the image within the portion of the memory in the interleaved format includes a plurality of components of the image color data such that each of the plurality of components represents one of a color value or a transparency value.

Example 9. A method performed by a processing system of a computing device for image decompression, including: decoding a metadata with a location identifier configured to describe locations of image color data of a portion of an image within a portion of a memory in an interleaved format; and identifying the locations of the image color data of the portion of the image within the portion of the memory in the interleaved format from the location identifier.

Example 10. The method of example 9, in which the metadata is image data format agnostic.

Example 11. The method of either of examples 9 or 10, in which identifying the locations of the image color data of the portion of the image within the portion of the memory in the interleaved format from the location identifier includes identifying the locations of the image color data of the portion of the image within the portion of the memory in the interleaved format from values that are associated with the location identifier, in which each of the values is configured to represent a location of one of multiple components of the image color data of the portion of the image within the portion of the memory in the interleaved format.

Example 12. The method of any of examples 9-11, in which decoding the metadata with the location identifier configured to describe the locations of the image color data of the portion of the image within the portion of the memory in the interleaved format includes locating values configured to represent locations of multiple components of the image color data of the portion of the image within the portion of the memory in the interleaved format based on the location identifier.

Example 13. The method of any of examples 9-11, in which decoding the metadata with the location identifier configured to describe the locations of the image color data of the portion of the image within the portion of the memory in the interleaved format includes generating values configured to represent locations of multiple components of the image color data of the portion of the image within the portion of the memory in the interleaved format based on the location identifier.

Example 14. The method of any of examples 9-13, in which the location identifier is configured to indicate to an image decoder device that a component of the image color data is one of compressed as part of a previous block, begins a first sized block, begins a second sized block, is a first constant value, or is a second constant value.

Example 15. The method of any of examples 9-14, in which the location identifier is configured to indicate to an image decoder device that all components of the image color data are a constant value.

Example 16. The method of any of examples 9-15, in which the location identifier is configured to indicate to an image decoder device that a beginning component of the image color data is one of begins a first sized block, begins a second sized block, is a first constant value, or is a second constant value.

Example 17. The method of any of examples 9-16, in which the image color data of the portion of the image within the portion of the memory in the interleaved format includes compressed image color data for at least one component of the image color data.

Example 18. The method of examples 9-17, in which the image color data of the portion of the image within the portion of the memory in the interleaved format includes a plurality of components of the image color data such that each of the plurality of components represents one of a color value or a transparency value.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method performed by a processing system of a computing device for image compression, comprising:
identifying locations of image color data of a portion of an image within a portion of a memory in an interleaved format; and
encoding a metadata with a location identifier configured to describe the locations of the image color data of the portion of the image within the portion of the memory in the interleaved format.

2. The method of claim 1, wherein encoding the metadata with the location identifier comprises encoding image data format agnostic metadata.

3. The method of claim 1, further comprising generating the location identifier based on the locations of the image color data of the portion of the image within the portion of the memory in the interleaved format.

4. The method of claim 1, wherein the location identifier is configured to indicate to an image decoder device that a component of the image color data is one of compressed as part of a previous block, begins a first sized block, begins a second sized block, is a first constant value, or is a second constant value.

5. The method of claim 1, wherein the location identifier is configured to indicate to an image decoder device that all components of the image color data are a constant value.

6. The method of claim 1, wherein the location identifier is configured to indicate to an image decoder device that a beginning component of the image color data is one of begins a first sized block, begins a second sized block, is a first constant value, or is a second constant value.

7. The method of claim 1, wherein the image color data of the portion of the image within the portion of the memory in the interleaved format includes compressed image color data for at least one component of the image color data.

8. The method of claim 1, wherein the image color data of the portion of the image within the portion of the memory in the interleaved format includes a plurality of components of the image color data such that each of the plurality of components represents one of a color value or a transparency value.

9. A computing device, comprising a processing system configured to:
identify locations of image color data of a portion of an image within a portion of a memory in an interleaved format; and
encode a metadata with a location identifier configured to describe the locations of the image color data of the portion of the image within the portion of the memory in the interleaved format.

10. The computing device of claim 9, wherein the processing system is configured to encode the metadata as image data format agnostic metadata.

11. The computing device of claim 9, wherein the processing system is further configured to generate the location identifier based on the locations of the image color data of the portion of the image within the portion of the memory in the interleaved format.

12. The computing device of claim 9, wherein the processing system is configured such that the location identifier is configured to indicate to an image decoder device that a component of the image color data is one of compressed as part of a previous block, begins a first sized block, begins a second sized block, is a first constant value, or is a second constant value, or that a beginning component of the image color data is one of begins the first sized block, begins the second sized block, is the first constant value, or is the second constant value.

13. The computing device of claim 9, wherein the processing system is configured such that the location identifier is configured to indicate to an image decoder device that all components of the image color data are a constant value.

14. The computing device of claim 9, wherein the processing system is configured such that the image color data of the portion of the image within the portion of the memory in the interleaved format includes compressed image color data for at least one component of the image color data.

15. The computing device of claim 9, wherein the processing system is configured such that the image color data of the portion of the image within the portion of the memory in the interleaved format includes a plurality of components of the image color data such that each of the plurality of components represents one of a color value or a transparency value.

16. A method performed by a processing system of a computing device for image decompression, comprising:
decoding a metadata with a location identifier configured to describe locations of image color data of a portion of an image within a portion of a memory in an interleaved format; and
identifying the locations of the image color data of the portion of the image within the portion of the memory in the interleaved format from the location identifier.

17. The method of claim 16, wherein the metadata is image data format agnostic.

18. The method of claim 16, wherein identifying the locations of the image color data of the portion of the image within the portion of the memory in the interleaved format from the location identifier comprises identifying the locations of the image color data of the portion of the image within the portion of the memory in the interleaved format from values that are associated with the location identifier, wherein each of the values is configured to represent a location of one of multiple components of the image color data of the portion of the image within the portion of the memory in the interleaved format.

19. The method of claim 16, wherein decoding the metadata with the location identifier configured to describe the locations of the image color data of the portion of the image within the portion of the memory in the interleaved format comprises locating values configured to represent locations of multiple components of the image color data of the portion of the image within the portion of the memory in the interleaved format based on the location identifier.

20. The method of claim 16, wherein decoding the metadata with the location identifier configured to describe the locations of the image color data of the portion of the image within the portion of the memory in the interleaved format comprises generating values configured to represent locations of multiple components of the image color data of the portion of the image within the portion of the memory in the interleaved format based on the location identifier.

21. The method of claim 16, wherein the location identifier is configured to indicate to an image decoder device that a component of the image color data is one of compressed as part of a previous block, begins a first sized block, begins a second sized block, is a first constant value, or is a second constant value.

22. The method of claim 16, wherein the location identifier is configured to indicate to an image decoder device that all components of the image color data are a constant value.

23. The method of claim 16, wherein the location identifier is configured to indicate to an image decoder device that a beginning component of the image color data is one of begins a first sized block, begins a second sized block, is a first constant value, or is a second constant value.

24. The method of claim 16, wherein the image color data of the portion of the image within the portion of the memory in the interleaved format includes compressed image color data for at least one component of the image color data.

25. The method of claim 16, wherein the image color data of the portion of the image within the portion of the memory in the interleaved format includes a plurality of components of the image color data such that each of the plurality of components represents one of a color value or a transparency value.

26. A computing device, comprising a processing system configured to:
decode a metadata with a location identifier configured to describe locations of image color data of a portion of an image within a portion of a memory in an interleaved format; and
identify the locations of the image color data of the portion of the image within the portion of the memory in the interleaved format from the location identifier.

27. The computing of claim 26, wherein the processing system is further configured to identify the locations of the image color data of the portion of the image within the portion of the memory in the interleaved format from values that are associated with the location identifier, wherein each of the values is configured to represent a location of one of multiple components of the image color data of the portion of the image within the portion of the memory in the interleaved format.

28. The computing of claim 26, wherein the processing system is further configured to locate values configured to represent locations of multiple components of the image color data of the portion of the image within the portion of the memory in the interleaved format based on the location identifier.

29. The computing of claim 26, wherein the processing system is further configured to generate values configured to represent locations of multiple components of the image color data of the portion of the image within the portion of the memory in the interleaved format based on the location identifier.

30. The computing of claim 26, wherein the processing system is further configured to obtain one of a color value or a transparency value from a plurality of components of the image color data of the portion of the image within the portion of the memory in the interleaved format.
